(19) United States
(12) Patent Application Publication
(10) Pub. No.: US 2012/0225969 A1
(43) Pub. Date: Sep. 6, 2012

(54) URETHANE (METH) ACRYLATE AND PRODUCTION METHOD THEREOF, CROSS-LINKED URETHANE (METH) ACRYLATE AND PRODUCTION METHOD THEREOF, AND LIGHT CURABLE AQUEOUS EMULSION

(75) Inventors: Toshiyuki Miyabayashi, Shiojiri (JP); Tomohito Nakano, Shiojiri (JP); Hiroki Nakane, Matsumoto (JP); Hirotoshi Koyano, Kobe (JP); Yoshinobu Sato, Osaka (JP); Hiroshi Sawada, Osaka-shi (JP); Shinichi Kato, Matsumo to (JP)

(73) Assignees: ARAKAWA CHEMICAL INDUSTRIES LTD, Osaka-shi (JP); SEIKO EPSON CORPORATION, Tokyo (JP)

(21) Appl. No.: 13/337,568

(22) Filed: Dec. 27, 2011

(30) Foreign Application Priority Data
Dec. 27, 2010 (JP) 2010-290092
Nov. 2, 2011 (JP) 2011-241449

(51) Int. Cl. C08G 18/83

(52) U.S. Cl. 522/53; 525/455; 522/149

(57) ABSTRACT

For the purpose of providing a urethane(meth)acrylate excellent in emulsifiability in water and a production method thereof, and a light curable aqueous emulsion using the urethane(meth)acrylate having a low viscosity and excellent in the curability, provided is a urethane(meth)acrylate being represented by the following general formula (1) and having a weight average molecular weight of 1,000 to 10,000:

A1-O—(CONH—B1-NHCOO—C1-O)n-CONH—B1-NH—COO-D1 (1)

wherein in formula (1), n represents a natural number of 1 to 30, A1 represents a residue of a hydroxyl group-containing (meth)acrylate, B1 represents a residue of diisocyanate, C1 represents a residue of a diol of an acyclic hydrocarbon or a cyclic hydrocarbon, and D1 represents a residue of a polyoxyalkylene glycol monoalkyl ether.

The entire disclosure of Japanese Patent Application No. 2010-290092, filed on Dec. 27, 2010, and No. 2011-241449, filed on Nov. 2, 2011, are expressly incorporated by reference herein.

### BACKGROUND OF THE INVENTION

1. Field of the Invention

The present invention relates to a urethane(meth)acrylate and a production method thereof, a cross-linked urethane(meth)acrylate and a production method thereof, and a light curable aqueous emulsion.

2. Description of the Related Art

Nowadays, due to the VOC (Volatile Organic Compounds) regulation and for the purpose of coping with this regulation, approaches to development of aqueous paints, adhesives, coating materials and the like free of organic solvents have been more actively performed than ever. In heat curable and ultraviolet curable paints, adhesives, coating materials and the like, oil-based multifunctional urethane(meth)acrylates having two or more (meth)acryloyl groups have hitherto been frequently used; however, recently, hydrophilic urethane(meth)acrylates have been attracting attention as materials for aqueous paints, adhesives, coating materials and the like.

Examples of such disclosed hydrophilic urethane(meth)acrylates include: a multifunctional urethane(meth)acrylate having, in the main chain, polyethylene oxide groups as hydrophilic groups and having two or more (meth)acryloyl groups at both terminals of the main chain; and a multifunctional urethane(meth)acrylate having a structure in which the main skeleton is a polyisocyanate having three or more isocyanate groups, and a molecular chain having at least one hydrophilic group and a molecular chain having at least two or more (meth)acryloyl groups are branched.

Among such urethane(meth)acrylates, as an example of the urethane(meth)acrylate having (meth)acryloyl groups at both terminals of the main chain, there is a hydrophilic urethane acrylate, disclosed in Japanese Patent Laid-Open No. 02-199102, using as the starting materials polyester polyol, isophorone diisocyanate and 2-hydroxydipropyl acrylate. As an example of a urethane(meth)acrylate having a branched structure, there is a hydrophilic urethane acrylate, disclosed in Japanese Patent Laid-Open No. 2007-191529, using as the starting materials a trimer of hexamethylene diisocyanate, pentaerythritol triacrylate and polyethylene glycol monomethyl ether.

However, it has never been possible to say that existing hydrophilic urethane(meth)acrylates are sufficient with respect to emulsifiability in water and emulsion stability in water. When the aqueous emulsion of such a urethane(meth)acrylate is used in aqueous paints, adhesives, coating materials and the like, the resulting materials tend to be high in viscosity, tend to undergo the occurrence of the variation of the viscosity depending on the production lot, and further, have sometimes been poor in long term stability with respect to the particle size distribution, the coating film performances and the like.

Aqueous emulsions of the aforementioned existing urethane(meth)acrylates are generally cured by dissolving a water-soluble photopolymerization initiator and by ultraviolet light irradiation after drying water. In this case, when water remains, the ultraviolet light irradiation sometimes result in no curing or insufficient curing. Commercially available water-soluble photopolymerization initiators are limited with respect to the amount dissolved in water, and hence the improvement of the curability is limited. On the other hand, hydrophobic photopolymerization initiators have also been used as dispersed in the water media of the aqueous emulsions of existing urethane(meth)acrylates; however, there occur the problems such as that the photopolymerization initiators are limited with respect to the amount dispersed in water media, or that the photopolymerization initiators are precipitated with time.

### SUMMARY OF THE INVENTION

Accordingly, the present invention takes as its object the provision of a urethane(meth)acrylate excellent in emulsifiability in water and a production method thereof, a cross-linked urethane(meth)acrylate and a production method thereof, and a light curable aqueous emulsion using the urethane(meth)acrylate and the cross-linked urethane(meth)acrylate having a low viscosity and excellent in the curability, for the purpose of solving these problems.

The present inventors made a diligent study for the purpose of solving the aforementioned problems. Consequently, the present inventors have perfected the present invention by discovering that the aforementioned problems can be solved by a urethane(meth)acrylate having a linear structure in which the structure derived from diisocyanate and the structure derived from diol are arranged on a straight line, wherein the urethane(meth)acrylate has a molecular structure in which a hydrophobic moiety and a hydrophilic moiety are located respectively at the opposite terminals of the linear main chain of the urethane(meth)acrylate.

Specifically, the present invention is as follows.

[1] A urethane(meth)acrylate being represented by the following general formula (1) and having a weight average molecular weight of 1,000 to 10,000:

A¹-O—(CONH—B¹—NHCOO—C¹—O)ₙ—CONH—B¹—NH—COO-D¹ (1)

wherein in formula (1), n represents a natural number of 1 to 30, A¹ represents a residue of a hydroxyl group-containing (meth)acrylate, B¹ represents a residue of diisocyanate, C¹ represents a residue of a diol of an acyclic hydrocarbon or a cyclic hydrocarbon, and D¹ represents a residue of a polyoxyalkylene glycol monoalkyl ether.

[2] The urethane(meth)acrylate according to [1], obtained by allowing to react with each other the hydroxyl group-containing (meth)acrylate, the diisocyanate, the diol of the acyclic hydrocarbon or the cyclic hydrocarbon and the polyoxyalkylene glycol monoalkyl ether.

[3] The urethane(meth)acrylate according to [1], wherein the diisocyanate is one or more selected from the group consisting of isophorone diisocyanate, hexamethylene diisocyanate, hydrogenated xylylene diisocyanate and hydrogenated diphenylmethane diisocyanate.

[4] The urethane(meth)acrylate according to [1], wherein the number of carbon atoms in the diol of the acyclic hydrocarbon or the cyclic hydrocarbon is 6 to 20.

[5] The urethane(meth)acrylate according to [4], wherein the diol, having a number of carbon atoms of 6 to 20, of the acyclic hydrocarbon or the cyclic hydrocarbon is one or more selected from the group consisting of 1,8-octanediol, 1,9-nonanediol, 1,10-decanediol, 1,11-undecanediol, 1,12-dodecanediol, 1,13-tridecanediol, 1,14-tetradecanediol, 1,15-pentadecanediol, 1,18-octadecanediol, 1,19-nonadecanediol, 1,20-eicosanediol, polypropylene glycol, aliphatic polycarbonate polyol, aliphatic polyester polyol, aliphatic polycaprolactone diol, hydrogenated bisphenol A, ethylene oxide-modified hydrogenated bisphenol A, propylene oxide-modified hydrogenated bisphenol A, 1,4-cyclohexanediol and tricyclodecanedimethanol.

[6] The urethane(meth)acrylate according to [1], wherein the hydroxyl group-containing (meth)acrylate is at least one of polypropylene glycol mono(meth)acrylate, pentaerythritol tri(meth)acrylate and dipentaerythritol penta(meth)acrylate.

[7] The urethane(meth)acrylate according to [1], wherein the polyoxyalkylene glycol monoalkyl ether is represented by the following general formula (2):

HO—(CH₂CH₂O)ₘ—R (2)

wherein in formula (2), R represents an alkyl group and m represents a natural number of 9 to 90.

[8] A cross-linked urethane(meth)acrylate comprising a constitutional unit including the urethane(meth)acrylate according to [1].

[9] The cross-linked urethane(meth)acrylate according to [8], prepared by cross-linking with a bifunctional or higher functional cross-linking agent.

[10] The cross-linked urethane(meth)acrylate according to [9], wherein the cross-linking agent is a mercapto group-containing compound.

[11] A light curable aqueous emulsion including: a urethane(meth)acrylate according to [1] or a cross-linked urethane(meth)acrylate according to [8]; and the compound having a radical polymerizable group(s) and the photoradical polymerization initiator emulsified and dispersed with the urethane(meth)acrylate or the cross-linked urethane(meth)acrylate.

[12] The light curable aqueous emulsion according to [11], wherein the compound having a radical polymerizable group(s) is a compound having in the molecule thereof three or more (meth)acryloyl groups.

[13] The light curable aqueous emulsion according to [11], wherein the photoradical polymerization initiator is a hydrophobic photopolymerization initiator.

[14] The light curable aqueous emulsion according to [11], wherein the photoradical polymerization initiator includes two or more photoradical polymerization initiators including at least a thioxanthone-based photoradical polymerization initiator.

[15] The light curable aqueous emulsion according to [11], wherein the compound having a radical polymerizable group(s) includes a urethane(meth)acrylate for fixing.

[16] The light curable aqueous emulsion according to [11], further including a fluorescent brightening agent.

[17] A production method of the urethane(meth)acrylate according to [1], the method comprising:

a first step of obtaining a first reaction product represented by the following general formula (1a),

OCN—(B¹—NHCOO—C¹—O)ₙ—CONH—B¹—NCO (1a)

by allowing the diisocyanate and the diol of the acyclic hydrocarbon or the cyclic hydrocarbon to react with each other;

a second step of obtaining a second reaction product represented by the following general formula (1b),

OCN—(B¹—NHCOO—C¹—O)ₙ—CONH—B¹—NH—COO-D¹ (1b)

by allowing the first reaction product and the polyoxyalkylene glycol monoalkyl ether to react with each other; and

a third step of allowing the second reaction product and the hydroxyl group-containing (meth)acrylate to react with each other.

[18] The production method of the urethane(meth)acrylate according to [17], wherein:

in the first step, the molar ratio between the diisocyanate and the diol of the acyclic hydrocarbon or the cyclic hydrocarbon is 5:1 to 5:4;

in the second step, the molar ratio between the first reaction product and the polyoxyalkylene glycol monoalkyl ether is 1:0.5 to 1:1; and

in the third step, the molar ratio between the second reaction product and the hydroxyl group-containing (meth)acrylate is 1:1.5 to 1:1.

[19] A production method of the cross-linked urethane(meth)acrylate according to [8], further comprising a fourth step of allowing the urethane(meth)acrylate represented by the foregoing general formula (1), obtained by the production method according to [17], and the bifunctional or higher functional cross-linking agent to react with each other.

[20] The production method of the cross-linked urethane(meth)acrylate according to [19], wherein in the fourth step, a compound having in the molecule thereof three or more (meth)acryloyl groups is further allowed to react with the bifunctional or higher functional cross-linking agent.

[21] The production method of the cross-linked urethane(meth)acrylate according to [19], wherein in the fourth step, a urethane(meth)acrylate for fixing is further added.

[22] The production method of the cross-linked urethane(meth)acrylate according to [20], wherein in the fourth step, the ratio between the content of the urethane(meth)acrylate represented by the foregoing general formula (1) and the compound having in the molecule thereof three or more (meth)acryloyl groups and the content of the bifunctional or higher functional cross-linking agent is 100:1 to 100:10 in terms of mass.

### BRIEF DESCRIPTION OF THE DRAWINGS

The invention will be described with reference to the accompanying drawings, wherein like numbers reference like elements.

FIG. 1 is a schematic diagram macroscopically illustrating the light curable aqueous emulsion of the present invention; and

FIG. 2 is a schematic diagram microscopically illustrating the light curable aqueous emulsion of the present invention.

### DETAILED DESCRIPTION OF THE PREFERRED EMBODIMENTS

Hereinafter, the embodiments for implementing the present invention are described in detail. The present invention is not limited to the following embodiments and can be implemented in various modifications within the scope of the gist of the present invention.

In the present specification, the “emulsifiability” means a property such that phase separation occurs or precipitation occurs when a light curable aqueous emulsion is allowed to stand still at 40° C.; the “curability” means a property such that polymerization and curing occur in the presence or absence of a photopolymerization initiator as a result of light irradiation; the “hydrolyzability” means a property such that hydrolysis occurs; and the “hydrophobic photopolymerization initiator” means a photopolymerization initiator having a solubility in water of 0.1% by mass or less.

Also, in the present specification, “(meth)acrylate” means at least either of an acrylate and a methacrylate corresponding to the acrylate, and “(meth)acryloyl” means at least either of an acryloyl and a methacryloyl corresponding to the acryloyl.

Urethane(Meth)Acrylate

An embodiment of the present invention relates to a urethane(meth)acrylate.

Constitution

The urethane(meth)acrylate of the present embodiment has a weight average molecular weight of 1,000 to 10,000 and is represented by the following general formula (1):

A¹-O—(CONH—B¹—NHCOO—C¹—O)ₙ—CONH—B¹—NH—COO-D¹ (1)

wherein in formula (1), n represents a natural number of 1 to 30, A¹ represents a residue of a hydroxyl group-containing (meth)acrylate, B¹ represents a residue of diisocyanate, C¹ represents a residue of a diol of an acyclic hydrocarbon or a cyclic hydrocarbon, and D¹ represents a residue of a polyoxyalkylene glycol monoalkyl ether.

The residue as referred to herein means, in the structure of the starting material of the urethane(meth)acrylate represented by the foregoing general formula (1), the moiety not including the functional group forming the urethane bond; specifically, the residue means the moiety (represented by A¹) not including the hydroxyl group in the case of the hydroxyl group-containing (meth)acrylate, the moiety (B¹) not including the isocyanate group in the case of diisocyanate, the moiety (C¹) not including the hydroxyl group in the case of the diol of an acyclic hydrocarbon or a cyclic hydrocarbon, and the moiety (D¹) not including the hydroxyl group in the case of the polyoxyalkylene glycol monoalkyl ether.

The weight average molecular weight of the urethane(meth)acrylate represented by the foregoing general formula (1) can be derived by measuring the molecular weight distribution on the basis of gel permeation chromatography (GPC). The weight average molecular weight as referred to in the present specification means the weight average molecular weight determined relative to polystyrene standards, and is measured with a GPC (HLC-8220 (trade name), manufactured by Tosoh Corporation) in which serially-connected three columns TSK-gel Super HZM-M (exclusion limit molecular weight: 4×10⁶, molecular weight fraction range: 266 to 4×10⁶, number of theoretical stages: 16,000 stages/column, packing material: styrene-based copolymer, packing particle size: 3 μm) are used.

The weight average molecular weight of the urethane(meth)acrylate represented by the foregoing general formula (1) is 1,000 to 10,000 and preferably 2,000 to 8,000. When the weight average molecular weight falls within the aforementioned range, the urethane(meth)acrylate tends to form micelles, is excellent in self-emulsifiability, and further there is obtained an advantageous effect such that hydrophobic substances tend to be included within the micelles. This is probably because the adoption of the urethane(meth)acrylate represented by the foregoing general formula (1) provides a satisfactory balance between hydrophilicity and hydrophobicity.

In the foregoing general formula (1), n represents a natural number of 1 to 30. The specific numerical value of n is determined by regulating the aforementioned weight average molecular weight.

Hydroxyl Group-Containing (Meth)Acrylate

The hydroxyl group-containing (meth)acrylate is a compound which gives the structure of A¹ in the foregoing general formula (1). The hydroxyl group-containing (meth)acrylate is used for the purpose of introducing a polymerizable group(s) into the foregoing general formula (1). Specifically, the hydroxyl group-containing (meth)acrylate used in the present embodiment is a compound having one or more (meth)acryloyl groups and one hydroxyl group, and the urethanation reaction of the hydroxyl group with one isocyanate group in the diisocyanate introduces a (meth)acryloyl group(s) to one terminal of the main chain of the urethane(meth)acrylate of the present embodiment. The introduction of at least one (meth)acryloyl group enables photopolymerization (photocuring), and the introduction of two or more (meth)acryloyl groups increases the photopolymerization rate and provides an advantageous effect to increase the hardness of the cured product.

The monofunctional monohydroxymono(meth)acrylate is not particularly limited; however, examples of the monohydroxymono(meth)acrylate include: 2-hydroxyethyl(meth)acrylate, 2-hydroxypropyl(meth)acrylate, polyethylene glycol mono(meth)acrylate, polypropylene glycol mono(meth)acrylate and polycaprolactone mono(meth)acrylate.

The bifunctional monohydroxydi(meth)acrylate is not particularly limited; however, examples of the monohydroxydi(meth)acrylate include glycerol di(meth)acrylate.

The trifunctional or higher functional monohydroxypoly(meth)acrylate is not particularly limited; however, examples of the monohydroxypoly(meth)acrylate include pentaerythritol tri(meth)acrylate and dipentaerythritol penta(meth)acrylate.

Because an emulsion having a low viscosity is obtained, preferable among these is polypropylene glycol mono(meth)acrylate and more preferable among these is polypropylene glycol monoacrylate. On the other hand, particularly because an emulsion excellent in curability is obtained, preferable as the hydroxyl group-containing (meth)acrylate is at least either of pentaerythritol tri(meth)acrylate and dipentaerythritol penta(meth)acrylate.

The aforementioned hydroxyl group-containing (meth)acrylates may be used each alone or in combinations of two or more thereof.

Diisocyanate

The diisocyanate is a compound which gives the structure of B¹ in the foregoing general formula (1). The diisocyanate means an organic diisocyanate having two reactive isocyanate groups in one molecule thereof.

A urethane(meth)acrylates synthesized by using an organic polyisocyanate having three or more isocyanate groups in the molecule thereof tends to be high in molecular weight and tends to be high in viscosity. The emulsion (aqueous emulsion) prepared by emulsifying in water such a urethane(meth)acrylate having the following structure also tends to be high in viscosity of emulsion (aqueous emulsion): the concerned structure has a hydrophilic group in the molecule of the urethane(meth)acrylate, wherein the main chain is formed of a polyisocyanate having three or more isocyanate groups, and the branched chains are formed of a molecular chain having at least one hydrophilic group and a molecular chain having at least two or more (meth)acryloyl groups.

On the contrary, the urethane(meth)acrylate synthesized by using a diisocyanate having two isocyanate groups in the molecule thereof has a linear structure in which: the structure derived from the diisocyanate and the structure derived from the diol are linearly arranged; and as shown in the foregoing general formula (1), there is at one terminal a hydrophilic group derived from polyoxyalkylene glycol monoalkyl ether, and there is arranged at the other terminal a hydrophobic moiety in which to a structure derived from a (meth)acrylate having one or more (meth)acryloyl group and one hydroxyl group, a structure derived from the diol of an acyclic hydrocarbon or a cyclic hydrocarbon having two hydroxyl groups in the molecule thereof is bonded through diisocyanate by urethane bond. Because of such a structure as described above, the urethane(meth)acrylate synthesized by using a diisocyanate having two isocyanate groups in the molecule thereof is particularly excellent in emulsifiability in water and can drastically reduce the viscosity of the emulsion (aqueous emulsion) as compared to the emulsions of the aforementioned conventional urethane(meth)acrylates.

The diisocyanate is not particularly limited; however, examples of the diisocyanate include: diisocyanates having an alicyclic hydrocarbon skeleton such as isophorone diisocyanate; diisocyanates having an aliphatic hydrocarbon skeleton such as hexamethylene diisocyanate; diisocyanates having an aromatic hydrocarbon skeleton such as xylylene diisocyanate, tolylene diisocyanate and diphenylmethane diisocyanate; and diisocyanates having a hydrogenated aromatic hydrocarbon skeleton such as hydrogenated xylylene diisocyanate and hydrogenated diphenylmethane diisocyanate.

Because there is obtained an advantageous effect such that the cured product of the urethane(meth)acrylate hardly undergoes yellowing due to sun light (ultraviolet light), preferable among these diisocyanates are one or more selected from the group consisting of isophorone diisocyanate, hexamethylene diisocyanate, hydrogenated xylylene diisocyanate and hydrogenated diphenylmethane diisocyanate.

The aforementioned diisocyanates may be used intramolecularly or intermolecularly each alone or in combinations of two or more thereof.

Diol of Acyclic Hydrocarbon or Cyclic Hydrocarbon

The diol of an acyclic hydrocarbon or a cyclic hydrocarbon is a compound which gives the structure of C¹ in the foregoing general formula (1). The diol is introduced for the purpose of regulating the degree of the hydrophobicity of the hydrophobic moiety of the urethane(meth)acrylate represented by the foregoing general formula (1). The diol is selected so as to provide a satisfactory hydrophobicity. As specific examples, one or more diols selected from the group consisting of aliphatic, alicyclic and aromatic diols each having two hydroxyl groups in one molecule thereof are preferably used; more preferable among such diols are diols exhibiting satisfactory hydrophobicity. Specifically, because of being particularly excellent in the concerned hydrophobicity, the number of the carbon atoms in the diol of the acyclic hydrocarbon or the cyclic hydrocarbon is preferably 6 to 20.

It is also possible to select as the diols, according to the intended use or intended purpose, those diols which are appropriate for controlling the rigidity or flexibility of the urethane(meth)acrylate and exhibit satisfactory hydrophobicity.

As the aforementioned aliphatic diols, heretofore known aliphatic diols can be used without imposing any particular restrictions as long as the aliphatic diols do not have in the molecule thereof any aromatic structure or any alicyclic structure. Specific examples of the aliphatic diol include: 1,8-octanediol, 1,9-nonanediol, 1,10-decanediol, 1,11-undecanediol, 1,12-dodecanediol, 1,13-tridecanediol, 1,14-tetradecanediol, 1,15-pentadecanediol, 1,18-octadecanediol, 1,19-nonadecanediol, 1,20-eicosanediol, polypropylene glycol (such as dipropylene glycol and tripropylene glycol), aliphatic polycarbonate polyol, aliphatic polyester polyol and aliphatic polycaprolactone diol.

As the aforementioned aromatic diols, heretofore known aromatic diols can be used without imposing any particular restrictions as long as the aromatic diols have in the molecule thereof an aromatic structure. Specific examples of the aromatic diol include: biphenyl-4,4′-diol, 1,4-benzenediol, bisphenol A, ethylene oxide-modified bisphenol A, propylene oxide-modified bisphenol A, aromatic polycarbonate polyol and aromatic polyester polyol.

As the aforementioned alicyclic diols, heretofore known alicyclic diols can be used without imposing any particular restrictions as long as the alicyclic diols have in the molecule thereof an alicyclic structure. Specific examples of the alicyclic diol include: hydrogenated bisphenol A, ethylene oxide-modified hydrogenated bisphenol A, propylene oxide-modified hydrogenated bisphenol A, 1,4-cyclohexanediol, tricyclodecanedimethanol, alicyclic polycarbonate polyol and alicyclic polyester polyol.

Because satisfactory emulsification in water is achieved and the cured product of the urethane(meth)acrylate hardly undergoes yellowing due to sun light (ultraviolet light), preferable among these are aliphatic diols and alicyclic diols. Preferable among the aliphatic diols are one or more selected from the group consisting of 1,8-octanediol, 1,9-nonanediol, 1,10-decanediol, 1,11-undecanediol, 1,12-dodecanediol, 1,13-tridecanediol, 1,14-tetradecanediol, 1,15-pentadecanediol, 1,18-octadecanediol, 1,19-nonadecanediol, 1,20-eicosanediol, polypropylene glycol, aliphatic polycarbonate polyol, aliphatic polyester polyol and aliphatic polycaprolactone diol. Preferable among the alicyclic diols are one or more selected from the group consisting of hydrogenated bisphenol A, ethylene oxide-modified hydrogenated bisphenol A, propylene oxide-modified hydrogenated bisphenol A, 1,4-cyclohexanediol and tricyclodecanedimethanol.

The aforementioned diols may be used intramolecularly or intermolecularly each alone or in combinations of two or more thereof.

Polyoxyalkylene Glycol Monoalkyl Ether

The polyoxyalkylene glycol monoalkyl ether is a compound which gives the structure of D¹ in the foregoing general formula (1). Polyoxyalkylene glycol monoalkyl ether is a compound in which one hydroxyl group of polyoxyalkylene glycol is blocked with an alkyl group, and is represented by the following general formula (2):

HO—(CH₂CH₂O)ₘ—R (2)

wherein in formula (2), R represents an alkyl group and m represents a natural number of 9 to 90.

The urethanation reaction of the hydroxyl group with one isocyanate group in the diisocyanate introduces the hydroxyl group to one terminal of the main chain of the urethane(meth)acrylate of the present embodiment. Consequently, the urethane(meth)acrylate of the present embodiment has a structure of an amphiphilic substance which has a hydrophilic moiety at one terminal of the linear main chain of the substance, and has a hydrophobic moiety constituted of one or more polymerizable (meth)acryloyl groups and hydrophobic groups at the other terminal of the linear main chain; thus, the urethane(meth)acrylate becomes particularly excellent in emulsifiability in water.

Because there is obtained an advantageous effect such that the hydrophilicity can be optionally regulated, the polyoxyalkylene glycol monoalkyl ether preferably includes in the molecule thereof a polyoxyethylene structure.

The polyoxyethylene structure is the repeated structure of the oxyethylene group. The average repetition number of the oxyethylene groups, namely, m in the foregoing general formula (2) is determined by regulating the balance between hydrophilicity and hydrophobicity so as to result in satisfactory emulsification in water of the urethane(meth)acrylate of the present embodiment, and is preferably a natural number of 9 to 90, more preferably a natural number of 9 to 60 and furthermore preferably a natural number of 9 to 30.

The polyoxyalkylene glycol monoalkyl ether is not particularly limited; however, examples of the polyoxyalkylene glycol monoalkyl ether include polyethylene glycol monoalkyl ethers such as polyethylene glycol monomethoxy ether and polyethylene glycol monoethoxy ether.

It is also possible to use polyoxyalkylene glycol monoalkyl ethers including in the molecules thereof, in addition to the polyoxyethylene structure, other polyoxyalkylene structures. In this case, it is preferable for emulsification that the polyoxyethylene structure be located on the side of the terminal alkyl group. Examples of the polyoxyalkylene structure usable in this case together with the polyoxyethylene structure include the polyoxypropylene structure and the polyoxytetramethylene structure. The repetition number of the oxyalkylene group of the polyoxyalkylene structure used together with the polyoxyethylene structure is appropriately determined in consideration of the balance between hydrophilicity and hydrophobicity of the concerned urethane(meth)acrylate.

The terminal alkyl group of the polyoxyalkylene glycol monoalkyl ether, namely, R in the foregoing general formula (2) is preferably a methyl group, an ethyl group or a propyl group, and more preferably a methyl group because the smaller is the number of carbon atoms of the alkyl group, the more the hydrophobicity is lowered and the more excellent is the emulsifiability.

The aforementioned polyoxyalkylene glycol monoalkyl ethers may be used each alone or in combinations of two or more thereof.

The urethane(meth)acrylates may also be used each alone or in combinations of two or more thereof, in a below-described light curable aqueous emulsion.

The content of the urethane(meth)acrylate is preferably 5 to 50% by mass and more preferably 10 to 40% by mass in relation to the total amount (100% by mass) of the light curable aqueous emulsion, for the purpose of enabling to form coating film and for the purpose of obtaining coating film performances such as satisfactory film strength and satisfactory adhesion, when the light curable aqueous emulsion of the present embodiment is used in aqueous paints, adhesives, coating materials and the like.

As described above, according to the present embodiment, a urethane(meth)acrylate excellent in self-emulsifying capability and emulsifiability can be provided.

Cross-Linked Urethane(Meth)Acrylate

The cross-linked urethane(meth)acrylate according to an embodiment of the present invention has a constitutional unit including the urethane(meth)acrylate of the aforementioned embodiment. The cross-linked urethane(meth)acrylate having as the constitutional unit the urethane(meth)acrylate represented by the general formula (1) is excellent in curability and more excellent in the storage stability of the emulsion.

Cross-Linking Agent

The aforementioned cross-linked urethane(meth)acrylate can be obtained by allowing the urethane(meth)acrylate of the aforementioned embodiment and a bifunctional or higher functional cross-linking agent to react with each other.

The use of a cross-linking agent enables to increase the molecular weight of the urethane(meth)acrylate. Thus, it is possible to obtain a cross-linked urethane(meth)acrylate more excellent in curability and more excellent in the storage stability of the emulsion.

Gelification can be prevented by performing the reaction, neither in a solvent system nor in a solvent-free system, but in the oil system (oil phase) in an O/W emulsion.

The aforementioned bifunctional or higher functional crosslinking agent is preferably hydrophobic because this cross-linking agent reacts with the (meth)acryloyl group. In other words, the aforementioned bifunctional or higher functional crosslinking agent undergoes the Michael addition, in the oil phase of an emulsion, to the (meth)acryloyl group in the urethane(meth)acrylate represented by the general formula (1), and thus cross-links the concerned urethane(meth)acrylate.

Examples of such a cross-linking agent reacting with the (meth)acryloyl group include cross-linking agents having thiol groups or amino groups in the molecules thereof. Among such cross-linking agents, either of a multifunctional thiol compound and a multifunctional amine compound is preferable because of the capability of allowing the reaction to proceed rapidly, a multifunctional thiol compound being more preferable.

The aforementioned bifunctional and higher functional crosslinking agent is not particularly limited; however, examples of such a crosslinking agent include mercapto group-containing compounds and amino group-containing compounds. Preferable among these compounds are mercapto group-containing compounds because of being low in solubility in water and tending to be incorporated into the oil phase when dispersed in water.

The aforementioned mercapto group-containing compound is not particularly limited; however, examples of the mercapto group-containing compound include pentaerythritol tetrakis(3-mercaptopropionate) (hereinafter, also referred to as “PEMP”), trimethylolpropane tris(3-mercaptopropionate), tris-[(3-mercaptopropionyloxy)-ethyl]-isocyanurate, tetraethylene glycol bis(3-mercaptopropionate), dipentaerythritol hexakis(3-mercaptopropionate), pentaerythritol tetrakis(3-mercaptobutyrate) and trimethylolpropane tris(3-mercaptobutyrate).

The content of the aforementioned bifunctional or higher functional cross-linking agent is preferably 3 to 10% by mass and more preferably 5 to 8% by mass in relation to the total mass (100% by mass) of the (meth)acryloyl group-containing resin.

The “(meth)acryloyl group-containing resin” as referred to in the present specification means all the resins that contain the (meth)acryloyl groups undergoing cross-linking due to the aforementioned crosslinking agents. Accordingly, the concerned (meth)acryloyl group-containing resin includes the urethane(meth)acrylate represented by the foregoing general formula (1) and the below-described compound having three or more (meth)acryloyl groups in the molecule thereof.

Production Method of Urethane(Meth)Acrylate

An embodiment of the present invention relates to a production method of a urethane(meth)acrylate. The present embodiment can be rephrased as a production method of the urethane(meth)acylate according to the aforementioned embodiment.

The production method of the urethane(meth)acrylate according to the present embodiment includes a first step, a second step and a third step.

In the first step, a first urethane bond-containing reaction product represented by the following general formula (1a) by allowing the diisocyanate and the diol of an acyclic hydrocarbon or a cyclic hydrocarbon preferably having 6 to 20 carbon atoms to react with each other:

OCN—(B¹—NHCOO—C¹—O)ₙ—CONH—B¹—NCO (1a)

In the first step, the molar ratio between the diisocyanate and the diol of an acyclic hydrocarbon or a cyclic hydrocarbon having 6 to 20 carbon atoms is preferably 5:1 to 5:4 and more preferably 5:2 to 5:3.

In the second step, a second reaction product represented by the following general formula (1b) is obtained by allowing the first reaction product and the polyoxyalkylene glycol monoalkyl ether to react with each other:

OCN—(B¹—NHCOO—C¹—O)ₙ—CONH—B¹—NH—COO-D¹ (1b)

In the second step, the molar ratio between the first reaction product and the polyoxyalkylene glycol monoalkyl ether is preferably 1:0.5 to 1:1 because of resulting in satisfactory emulsification in water.

In the third step, the second reaction product and the hydroxyl group-containing (meth)acrylate are allowed to react to each other. In the third step, the molar ratio between the second reaction product and the hydroxyl group-containing (meth)acrylate is preferably 1:1.5 to 1:1 and more preferably 1:1.4 to 1:1.2.

As described above, according to the present embodiment, a production method of a urethane(meth)acrylate excellent in self-emulsifying capability and emulsifiability can be provided.

Production Method of Cross-Linked Urethane(Meth)Acrylate

The production method of a cross-linked urethane(meth)acrylate according to one embodiment of the present invention is a production method of the cross-linked urethane(meth)acrylate of the aforementioned embodiment. The concerned production method includes a fourth step in which the urethane(meth)acrylate represented by the general formula (1), obtained by performing the first step to the third step and the aforementioned bifunctional or higher functional cross-linking agent are allowed to react with each other, so that the concerned urethane(meth)acrylate is cross-linked.

In the fourth step, in addition to the urethane(meth)acrylate represented by the foregoing general formula (1), the aforementioned compound having in the molecule thereof three or more (meth)acryloyl groups may also be allowed to react with the bifunctional or higher functional cross-linking agent.

In the fourth step, a urethane(meth)acrylate for fixing may further be added. In particular, when the substrate is made of polyvinyl chloride (hereinafter, also referred to as “PVC”), it is preferable to further add a urethane(meth)acrylate for fixing. Specifically, when a PVC substrate is used, the coating film (to be described below) is required to have adhesiveness to the PVC substrate. In this connection, the addition of the urethane(meth)acrylate for fixing makes satisfactory the adhesiveness to the substrate, and hence it can be said that the use of the urethane(meth)acrylate for fixing is preferable.

When a substrate made of a material other than PVC, for example, polyethylene terephthalate (PET) is used, the curability is made more satisfactory and the storage stability of the emulsion is more excellent because of the reason that the particles are fined, and hence the content (addition amount) of the urethane(meth)acrylate for fixing is preferably low, and the content of the compound having three or more (meth)acryloyl groups is preferably set at a correspondingly larger value.

In the fourth step, the ratio between the content of the urethane(meth)acrylate represented by the foregoing general formula (1) and (when present) the compound having in the molecule thereof three or more (meth)acryloyl groups and the content of the bifunctional or higher functional cross-linking agent is preferably 100:1 to 100:10 and more preferably 100:5 to 100:8 in terms of mass. When the content ratio is equal to or more than the lower limit of the aforementioned range, the curability and the storage stability come to be more excellent. When the content ratio is equal to or less than the upper limit of the aforementioned range, the occurrence of undissolved substances can be prevented, and the vanishing of the (meth)acryloyl group in the system is prevented and thus the curability can be maintained more satisfactory.

As described above, in the fourth step, the urethane(meth)acrylate represented by the foregoing general formula (1), the bifunctional or higher functional cross-linking agent such as a multifunctional thiol monomer, and one or more, as the optional components, selected from the group consisting of the compound having in the molecule thereof three or more (meth)acryloyl groups, the urethane(meth)acrylate for fixing, the photoradical polymerization initiator preferably included thioxanthone-based initiators and the fluorescent brightening agent are mixed together, and the resulting mixture is emulsified (dispersed in water) by dropwise adding water to the mixture. The obtained emulsion is heated, for example, at 80° C. for 6 hours, and consequently the Michael addition reaction is accelerated to yield the cross-linked urethane(meth)acrylate.

In this case, the compound having a (meth)acryloyl group and the cross-linking agent react with each other and consequently the compound having a (meth)acryloyl group is cross-linked. In other words, the cross-linking agent reacts not only with the urethane(meth)acrylate but with the compound having a (meth)acryloyl group. Accordingly, in the structure of the cross-linked urethane(meth)acrylate, there can be concomitantly present various cross-linked compounds such as a compound resulting from the mutual cross-linking of the urethane(meth)acrylates represented by the general formula (1), a compound resulting from the cross-linking between the urethane(meth)acrylate represented by the general formula (1) and the (meth)acryloyl group-containing compound, which is an included substance, and a compound resulting from the mutual crosslinking of the (meth)acryloyl group-containing compounds, which are included substances. The included substance as referred to herein means a substance present in the interior of a micelle when an emulsion is formed and a micelle structure is obtained.

As described above, when the compound having a (meth)acryloyl group and the cross-linking agent are allowed to react with each other, there occur a case where the whole of the compound having a (meth)acryloyl group is cross-linked and a case where part of the compound having a (meth)acryloyl group is cross-linked and the rest of the compound having a (meth)acryloyl group remains uncross-linked. A catalyst may also be used for the purpose of further accelerating the aforementioned Michael addition reaction.

Light Curable Aqueous Emulsion

An embodiment of the present invention relates to a light curable aqueous emulsion. The light curable aqueous emulsion includes: at least either of the urethane(meth)acrylate represented by the general formula (1) of the aforementioned embodiment and the cross-linked urethane(meth)acrylate of the aforementioned embodiment; and a compound having a radical polymerizable group(s) (preferably, a radical polymerizable (meth)acrylate) and a photoradical polymerization initiator (photoradical polymerization initiator) emulsified and dispersed in water by at least either of the concerned urethane(meth)acrylate and the concerned cross-linked urethane(meth)acrylate. The urethane(meth)acrylate represented by the general formula (1) of the aforementioned embodiment and the cross-linked urethane(meth)acrylate of the aforementioned embodiment are amphiphilic substances, and hence it is made possible to obtain a light curable aqueous emulsion achieving advantageous effects such that the emulsion is stable and excellent in dispersibility and is low in viscosity.

Hereinafter, “the urethane(meth)acrylate of the aforementioned embodiment” means both of the urethane(meth)acrylate represented by the general formula (1) and the aforementioned cross-linked urethane(meth)acrylate.

The aforementioned effects due to the light curable aqueous emulsion of the present embodiment are probably brought about by the following reasons.

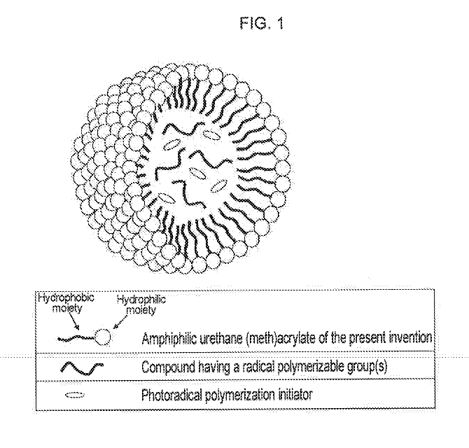

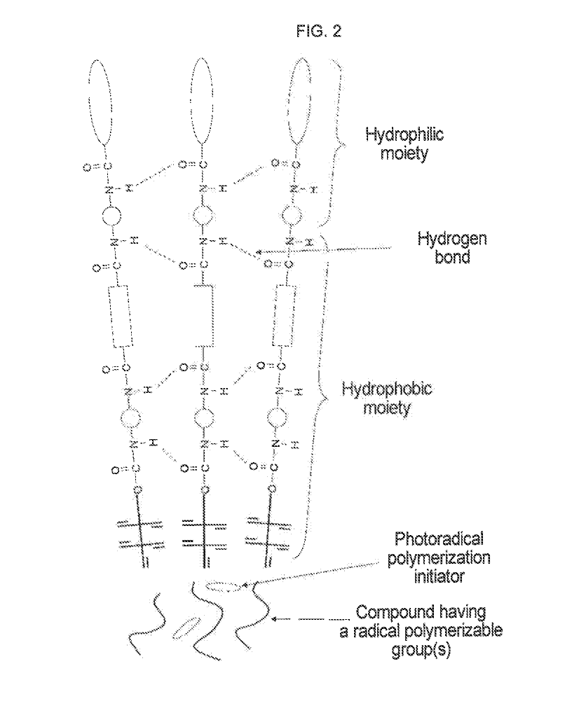

FIG. 1 is a schematic diagram macroscopically illustrating an ultraviolet curable aqueous emulsion of an example of the light curable aqueous emulsion of the present embodiment; and FIG. 2 is a schematic diagram microscopically illustrating the ultraviolet curable aqueous emulsion of an example of the light curable aqueous emulsion of the present embodiment. As shown in FIGS. 1 and 2, the urethane(meth)acrylate of the aforementioned embodiment probably forms micelles in water in such a way that the hydrophobic moiety is directed toward the core and the hydrophilic moiety is directed toward the water phase to form the shell layer, and thus the urethane(meth)acrylate probably can form in water micelles including the compound having a radical polymerizable group(s) (preferably radical polymerizable (meth)acrylate) and the photoradical polymerization initiator.

Such a micelle formation as described above is probably ascribable to the molecular structure of the urethane(meth)acrylate of the aforementioned embodiment. Specifically, in the micelle formation, the molecular structure of the urethane(meth)acrylate of the aforementioned embodiment is smaller in steric hindrance as compared to the case where the main chain is branched or the main chain has hydrophobic moieties at both terminals thereof, and is probably free from bend conformation. Accordingly, it becomes possible that the urethane(meth)acrylate is regularly densely oriented with the hydrophilic moiety directed toward the water phase. Thus, in the micelle in which the urethane(meth)acrylate molecules are densely oriented, the hydrogen bonds between the urethane bonds operate effectively to increase the micelle formation strength (packing property) so as to probably contribute to the stability and the dispersibility of the micelles.

Probably thus, the light curable aqueous emulsion is excellent in stability and a satisfactory photopolymerizability is obtained even when the compound having a radical polymerization group(s) (preferably, radical polymerizable (meth)acrylate) and the photoradical polymerization initiator are included in the micelles.

Compound Having Radical Polymerizable Group(s)

The compound having a radical polymerizable group(s) used in the present embodiment undergoes a reaction in a chain-like manner, under the attack of the below-described initiator radical generated by the irradiation of light having a specific wavelength (a specific wavelength range). At the same time, the acryloyl group(s) of the urethane(meth)acrylate of the aforementioned embodiment present in the same uniform field as the field in which the radical polymerizable compound is present also undergoes a reaction in a chain-like manner. In this way, the light curable aqueous emulsion of the present embodiment forms a cured coating film on the substrate.

Examples of the radical polymerizable group(s) in the compound having a radical polymerizable group(s) include a (meth)acryloyl group, a vinyl group, a vinyl ether group and a mercapto group.

As the compound having a radical polymerizable group(s) used in the present embodiment, a compound having in the structure thereof one or more (meth)acryloyl groups is particularly preferable, and a compound having in the structure thereof one or more acryloyl groups is more preferable. The compound having one or more radical polymerizable groups includes a monomer having a molecular weight of about a few hundreds, oligomers ranging from a dimer to a lower polymer consisting of several monomer units, having a molecular weight of approximately several thousands or less, and polymers having a molecular weight of several tens of thousands or less.

The compound having a radical polymerizable group(s) that has in the molecule thereof one (meth)acryloyl group is not particularly limited; however, examples of such a compound include: isoamyl(meth)acrylate, stearyl(meth)acrylate, lauryl(meth)acrylate, octyl(meth)acrylate, decyl(meth)acrylate, isomyristyl(meth)acrylate, isostearyl(meth)acrylate, 2-ethylhexyl-diglycol (meth)acrylate, 2-hydroxybutyl(meth)acrylate, butoxyethyl(meth)acrylate, ethoxy diethylene glycol(meth)acrylate, methoxy diethylene glycol (meth)acrylate, methoxy polyethylene glycol (meth)acrylate, methoxy propylene glycol (meth)acrylate, phenoxyethyl(meth)acrylate, tetrahydrofurfuryl(meth)acrylate, 2-hydroxyethyl(meth)acrylate, 2-hydroxypropyl(meth)acrylate, 2-hydroxy-3-phenoxypropyl(meth)acrylate, lactone-modified flexible (meth)acrylate, t-butylcyclohexyl(meth)acrylate, dicyclopentenyl(meth)acrylate, dicyclopentenyloxyethyl(meth)acrylate, glycidyl(meth)acrylate. and isobornyl(meth)acrylate.

The compound having a radical polymerizable group(s) that has in the molecule thereof two (meth)acryloyl groups is not particularly limited; however, examples of such a compound include: triethylene glycol di(meth)acrylate, tetraethylene glycol di(meth)acrylate, polyethylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dimethylol-tricyclodecane di(meth)acrylate, bisphenol A EO (ethylene oxide) adduct di(meth)acrylate, bisphenol A PO (propylene oxide) adduct di(meth)acrylate, neopentyl hydroxypivalate glycol di(meth)acrylate and polytetramethylene glycol di(meth)acrylate.

Among these, compounds having in the molecule thereof three or more (meth)acryloyl groups are more preferable as the compound having a radical polymerizable group(s) because such compounds are excellent in photopolymerizability.

The compound having a radical polymerizable group(s) that has in the molecule thereof three or more (meth)acryloyl groups is not particularly limited; however, examples of such a compound include: trimethylolpropane tri(meth)acrylate, ethylene oxide-modified trimethylolpropane tri(meth)acrylate, propylene oxide-modified trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, ditrimethylolpropane tetra(meth)acrylate, glycerol tri(meth)acrylate, glycerin ethoxy tri(meth)acrylate, glycerin propoxy tri(meth)acrylate, caprolactone-modified trimethylolpropane tri(meth)acrylate, pentaerythritol ethoxy tetra(meth)acrylate, epichlorohydrin-modified trimethylolpropane tri(meth)acrylate, tripentaerythritol octa(meth)acrylate, tetrapentaerythritol deca(meth)acrylate, polypentaerythritol poly(meth)acrylate and caprolactone-modified dipentaerythritol hexa(meth)acrylate.

The aforementioned compound having in the molecule thereof three or more (meth)acryloyl groups is not particularly limited; however, examples of such a compound include: oligomers having a molecular weight of approximately several thousands or less and having three or more (meth)acryloyl groups such as polyester(meth)acrylate, polyurethane(meth)acrylate (with the proviso that the aforementioned urethane(meth)acrylate is excluded), epoxy(meth)acrylate, polyether (meth)acrylate, oligo(meth)acrylate, alkyd (meth)acrylate and polyol (meth)acrylate; oligomers having in the molecule thereof three or more acryloyl groups and having a molecular weight of approximately several thousands or less; and polymer and dendrimer type (meth)acrylates having a molecular weight of approximately several ten thousands or less.

The aforementioned compounds having a radical polymerizable group(s) may be used each alone or in combinations of two or more thereof.

Because the compound having a radical polymerizable group(s) imparts high photopolymerizability (curability) to the light curable aqueous emulsion, the compound having a radical polymerizable group(s) is included preferably in a content of 1 to 60% by mass and more preferably 5 to 50% by mass in relation to the total amount (100% by mass) of the light curable aqueous emulsion.

Urethane(Meth)Acrylate for Fixing

The aforementioned compound having a radical polymerizable group(s) preferably includes a urethane(meth)acrylate for fixing. Thus, when a coating film including an emulsion is formed on a PVC substrate, the fixability (adhesiveness) of the coating film is made more excellent. As described above, because the compound having a radical polymerizable group(s) preferably includes a compound excellent in photopolymerizability (curability), it is preferable to use a urethane(meth)acrylate for fixing, making the adhesiveness more satisfactory, in combination with the concerned compound.

It is to be noted that the concerned urethane(meth)acrylate for fixing is different from the urethane(meth)acrylate represented by the foregoing general formula (1).

As described below, the urethane(meth)acrylate for fixing is constituted of a diisocyanate, a diol component having an aromatic skeleton and a hydroxyl group-containing (meth)acrylate.

The weight average molecular weight of the urethane(meth)acrylate for fixing is particularly preferably 1,000 to 10,000 and more preferably 3,000 to 8,000. When the weight average molecular weight falls within the aforementioned range, the urethane(meth)acrylate for fixing is excellent in the adhesiveness of the coating film to the PVC substrate and satisfactory with respect to the stability of the emulsion.

Hydroxyl Group-Containing (Meth)Acrylate

The hydroxyl group-containing (meth)acrylate is used for the purpose of introducing polymerizable groups. Specifically, the hydroxyl group-containing (meth)acrylate used in the present embodiment has one or more (meth)acryloyl groups and one hydroxyl group, and the urethanation reaction of the hydroxyl group-containing (meth)acrylate with an isocyanate group introduces one or more (meth)acryloyl groups to each of the both terminals of the main chain of the urethane(meth)acrylate for fixing. The introduction of at least one (meth)acryloyl group enables curing (photopolymerization), and the introduction of two or more (meth)acryloyl groups enables the increase of the curing rate and enables the increase of the hardness of the cured product.

Monohydroxy mono(meth)acrylate is not particularly limited; however, examples of monohydroxy mono(meth)acrylate include: 2-hydroxyethyl(meth)acrylate, 2-hydroxypropyl(meth)acrylate, polyethylene glycol mono(meth)acrylate, polypropylene glycol mono(meth)acrylate, polycaprolactone mono(meth)acrylate, glycerol di(meth)acrylate, pentaerythritol tri(meth)acrylate and dipentaerythritol penta(meth)acrylate.

The aforementioned hydroxyl group-containing (meth)acrylate may be used each alone or in combinations of two or more thereof.

Diisocyanate

The diisocyanate is not particularly limited; however, examples of the diisocyanate include: diisocyanates having a alicyclic hydrocarbon skeleton such as isophorone diisocyanate; diisocyanates having an aliphatic hydrocarbon skeleton such as hexamethylene diisocyanate; diisocyanates having an aromatic hydrocarbon skeleton such as xylylene diisocyanate, tolylene diisocyanate and diphenylmethane diisocyanate; and diisocyanates having a hydrogenated aromatic hydrocarbon skeleton such as hydrogenated xylylene diisocyanate and hydrogenated diphenylmethane diisocyanate.

Because the cured product of the urethane(meth)acrylate for fixing hardly undergoes yellowing due to sun light (ultraviolet light), preferable among these diisocyanates are one or more selected from the group consisting of isophorone diisocyanate, hexamethylene diisocyanate, hydrogenated xylylene diisocyanate and hydrogenated diphenylmethane diisocyanate.

The aforementioned diisocyanates may be used intramolecularly or intermolecularly each alone or in combinations of two or more thereof.

Diol Component Having Aromatic Skeleton

As the diol having an aromatic skeleton, heretofore known diols having an aromatic skeleton can be used without imposing any particular restrictions as long as the diols have in the molecule thereof an aromatic structure. Specific examples of the diol having an aromatic skeleton include: biphenyl-4,4′-diol, 1,4-benzenediol, bisphenol A, ethylene oxide-modified bisphenol A, propylene oxide-modified bisphenol A, aromatic polycarbonate polyol and aromatic polyester polyol.

Preferable among these is aromatic polyester polyol, because of being more satisfactory in the adhesiveness to the PVC substrate. Isophthalate is more preferable among aromatic polyester polyols.

The aforementioned diols may be used intramolecularly or inter molecularly each alone or in combinations of two or more thereof.

The content of the urethane(meth)acrylate of the aforementioned embodiment is preferably 0.5 to 4% by mass and more preferably 1 to 3% by mass in relation to the total amount (100% by mass) of the light curable aqueous emulsion because of being more excellent in the adhesiveness to the PVC substrate and the stability after dispersion in water.

Photoradical Polymerization Initiator

The photoradical polymerization initiator used in the present embodiment causes photoradical polymerization as follows: the photocleavage, hydrogen abstraction or the like due to the irradiation of the photoradical polymerization initiator with an active energy ray such as ultraviolet light (UV) produces a radical (photoradical polymerization initiator radical), and the radical attacks the urethane(meth)acrylate of the aforementioned embodiment, the cross-linked urethane(meth)acrylate of the aforementioned embodiment and the compound having a radical polymerizable group(s) (preferably a radical polymerizable (meth)acrylate) to cause photoradical polymerization.

The photoradical polymerization initiator is preferably a hydrophobic photopolymerization initiator because the hydrophobic photopolymerization initiator exhibits a satisfactory emulsifying dispersibility when emulsified and dispersed in water with the urethane(meth)acrylate of the present embodiment.

The hydrophobic photopolymerization initiator is not particularly limited; however, specific examples of the hydrophobic photopolymerization initiator include: acetophenone, 2,2-diethoxyacetophenone, p-dimethylaminoacetophenone, benzophenone, 2-chlorobenzophenone, p,p′-dichlorobenzophenone, p,p′-bisdiethylaminobenzophenone, Michler's ketone, benzil, benzoin, benzoin methyl ether, benzoin ethyl ether, benzoin isopropyl ether, benzoin n-propyl ether, benzoin isobutyl ether, benzoin n-butyl ether, benzyl methyl ketal, 2,2-dimethoxy-1,2-diphenylethan-1-one, 1-hydroxycyclohexyl phenyl ketone, 2-hydroxy-1-{4-[4-(2-hydroxy-2-methylpropionyl)benzyl]phenyl}-2-methylpropan-1-one, 2-benzyl-2-dimethylamino-1-(4-morpholinophenyl)butanone-1,2-dimethylamino-2-(4-methylbenzyl)-1-(4-morpholin-4-yl-phenyl)butan-1-one, 2,4,6-trimethylbenzoyl diphenyl phosphine oxide, bis(2,4,6-trimethylbenzoyl)phenyl phosphine oxide, bis(2,6-dimethoxybenzoyl)-2,4,4-trimethylpentyl phosphine oxide, 2-methyl-1-[4-(methylthio)phenyl]-2-morpholinopropan-1-one, thioxanthone, 2-chlorothioxanthone, 2-methylthioxanthone, 2-isopropylthioxanthone, 4-isopropylthioxanthone, 2-hydroxy-2-methyl-1-phenyl-1-one, 1-(4-isopropylphenyl)-2-hydroxy-2-methylpropan-1-one, methyl benzoyl formate, azobisisobutylonitrile, benzoyl peroxide and di-tert-butyl peroxide.

Examples of the commercially available product of the photoradical polymerization initiator include: IRGACURE 651 (2,2-dimethoxy-1,2-diphenylethan-1-one), IRGACURE 184 (1-hydroxy-cyclohexyl-phenyl-ketone), DAROCUR 1173 (2-hydroxy-2-methyl-1-phenyl-propan-1-one), IRGACURE 2959 (1-[4-(2-hydroxyethoxy)-phenyl]-2-hydroxy-2-methyl-1-propan-1-one), IRGACURE 127 (2-hydroxy-1-{(4-[4-(2-hydroxy-2-methyl-propionyl)-benzyl]phenyl-2-methyl-propan-1-one}, IRGACURE 907 (2-methyl-1-(4-methylthiophenyl)-2-morpholinopropan-1-one), IRGACURE 369 (2-benzyl-2-dimethylamino-1-(4-morpholinophenyl)-butanone-1), IRGACURE 379 (2-(dimethylamino)-2-[(4-methylphenyl)methyl]-1-[4-(4-morpholinyl)phenyl]-1-butanone), DAROCUR TPO (2,4,6-trimethylbenzoyl-diphenyl-phosphine oxide), Speedcure TPO (2,4,6-trimethylbenzoyl-diphenyl-phosphine oxide), IRGACURE 819 (bis(2,4,6-trimethylbenzoyl)-phenylphosphine oxide), IRGACURE 784 (bis(η5-2,4-cyclopentadien-1-yl)-bis(2,6-difluoro-3-(1H-pyrrol-1-yl)-phenyl)titanium), IRGACURE OXE 01 (1,2-octanedione-1-[4-(phenylthio)-2-(O-benzoyloxime)]), IRGACURE OXE 02 (ethanone, 1-[9-ethyl-6-(2-methylbenzoyl)-9H-carbazol-3-yl]-, 1-(O-acetyloxime)), IRGACURE 754 (mixture of oxyphenylacetic acid 2-[2-oxo-2-phenylacetoxyethoxy]ethyl ester and oxyphenylacetic acid 2-(2-hydroxyethoxy)ethyl ester) (the foregoing, manufactured by BASF Corp.); DETX-S (2,4-diethylthioxanthone (manufactured by Nippon Kayaku Co., Ltd.); Lucirin TPO, LR8893 and LR8970 (the foregoing, manufactured by BASF Corp.); and Ubecryl P36 (manufactured by UCB Co., Ltd.).

When the light curable aqueous emulsion of the present embodiment is used for a material such as a paint, an adhesive or a coating material, the light curable aqueous emulsion is frequently required to be cured to the deep portion of the applied material; among the aforementioned photoradical polymerization initiators, the phenylphosphine-based photoradical polymerization initiators exhibiting absorption in a wavelength range from 360 nm to 410 nm are preferably used for curing of thick films. Specifically, examples of such initiators preferably include 2,4,6-trimethylbenzoyl-diphenyl-phosphine oxide and bis(2,4,6-trimethylbenzoyl)-phenylphosphine oxide. Examples of the commercially available products of such initiators include DAROCUR TPO (manufactured by BASF Corp.), Speedcure TPO (manufactured by Lambson Group Ltd.) and IRGACURE 819 (manufactured by BASF Corp.).

The photoradical polymerization initiators may be used each alone or in combinations of two or more thereof. The photoradical polymerization initiator is included in a content of preferably 1 to 10% by mass, more preferably 3 to 10% by mass and further preferably 5 to 10% by mass in relation to the total amount (100% by mass) of the light curable aqueous emulsion. In particular, the range within 5 to 10% by mass results in satisfactory curability.

In particular, when two or more photoradical polymerization initiators are used, such initiators preferably include at least a thioxanthone-based photoradical polymerization initiator, and more preferably includes both of a phenylphosphine-based photoradical polymerization initiator and a thioxanthone-based photoradical polymerization initiator. In this case, because the thioxanthone-based photoradical polymerization initiator is excellent in sensitization effect, the curability is made more excellent.

The thioxanthone-based photoradical polymerization initiator is not particularly limited; however, examples of such an initiator include thioxanthone, 2-methylthioxanthone, 2,4-diethylthioxanthone, 2-isopropylthioxanthone, 4-isopropylthioxanthone, 2-chlorothioxanthone and 2,4-diethylthioxanthone.

Examples of the commercially available product of the thioxanthone-based photoradical polymerization initiator include: KAYACURE DETX-S (trade name of 2,4-diethylthioxanthone, manufactured by Nippon Kayaku Co., Ltd.), Speedcure DETX (trade name of 2,4-diethylthioxanthone, manufactured by Lambson Ltd.) and KAYACURE ITX (trade name of 2-/4-isopropylthioxanthone, manufactured by Nippon Kayaku Co., Ltd.).

Fluorescent Brightening Agent

The light curable aqueous emulsion of the present embodiment preferably further includes a fluorescent brightening agent in addition to the photoradical polymerization initiator. Thus, the curability is made more excellent.

The fluorescent brightening agent used in the present embodiment is classified as a sensitizer. The fluorescent brightening agent is a colorless or slightly colored compound capable of absorbing light having a peak wavelength approximately in a range from near ultraviolet to short wavelength visible light, namely, a wavelength range from 300 to 450 nm and capable of emitting fluorescence having a peak wavelength approximately in a range from 400 to 500 nm. The fluorescent brightening agent is also known as the fluorescent whitening agent. The physical principles and the chemical properties of the fluorescent brightening agent is described in Ullmann's Encyclopedia of Industrial Chemistry, Sixth Edition, Electronic Release, Wiley-VCH, 1998.

The fluorescent brightening agent is excited to an excited state with an active energy ray and can accelerate the generation of useful groups such as radicals and acids through the interactions such as energy transfer and electron transfer with other substances such as radical generating agents and acid generating agents. Examples of the case of the occurrence of such interactions include a case where the energy level of the triplet excited state of the fluorescent brightening agent molecule and the energy level of the triplet excited state of the radical generating agent or the acid generating agent are extremely close to each other, and additionally, the energy level of the triplet excited state of the radical generating agent or the acid generating agent is slightly lower than the energy level of the triplet excited state of the fluorescent brightening agent. Actually, it is required that the fluorescent brightening agent be capable of capturing the irradiation light in a wavelength band of from 350 nm to 450 nm, and additionally, the energy level of the triplet excited state of the fluorescent brightening agent have the aforementioned specific relation with the energy level of the triplet excited state of the radical generating agent or the acid generating agent. In order to meet this requirement, it is required that the energy level of the singlet exited state and the energy level of the triplet excited state be close to each other. Accordingly, also included is the case where the fluorescent brightening agent is used from the viewpoint of the interaction with the radical generating agent or the acid generating agent, and at the same time, the absorption wavelength band of the photoradical polymerization initiator overlaps with the absorption wavelength band of the fluorescent brightening agent from the viewpoint of the generation efficiency, as the ink liquid, of the radical or acid with respect to the irradiation wavelength. In this case, the fluorescent brightening agent in the present embodiment has an absorption region in the wavelength band at least partially overlapping with the absorption wavelength band of the photopolymerization initiator, capable of performing cleavage thereof.

The fluorescent brightening agent is not particularly limited; however, examples of the fluorescent brightening agent include: naphthalene benzoxazolyl derivatives, thiophene benzoxazolyl derivatives, stilbene benzoxazolyl derivatives, coumarin derivatives, styrene biphenyl derivatives, pyrazolone derivatives, stilbene derivatives, styryl derivatives of benzene and biphenyl, bis(benzazol-2-yl) derivatives, carbostyrils, naphthalimides, derivatives of dibenzothiophene-5,5′-dioxide, pyrene derivatives and pyridotriazoles. These may be used each alone or in combinations of two or more thereof.

Examples of the commercially available product of the fluorescent brightening agent used in the present embodiment include TINOPAL OB manufactured by BASF Corp. and HOSTALUX KCB (1,4-bis(2-benzoxazolyl)naphthalene) manufactured by Clariant (Japan) K.K.

The fluorescent brightening agent used in the present embodiment has a feature such that the maximum absorbance of the fluorescent brightening agent per a predetermined concentration in a wavelength band of from 360 nm to 420 nm is larger than the maximum absorbance per the same concentration as the aforementioned predetermined concentration of the photopolymerization initiator in the aforementioned wavelength band. The present inventors have found that the fulfillment of this feature results in an ink composition extremely excellent in curability.

In the design method for allowing the photopolymerization initiator and the fluorescent brightening agent to fulfill the aforementioned feature, the absorption spectrum, and the maximum absorbance and the peak wavelength of the absorption spectrum of each of the photopolymerization initiator to be used and the fluorescent brightening agent to be used are analyzed. Then, it is only required to verify whether or not the relation between the maximum absorbance of the photopolymerization initiator and the maximum absorbance of the fluorescent brightening agent fulfills the aforementioned feature.

When an ultraviolet light-emitting diode (LED) is used as the light source used for measuring the absorption spectra of the fluorescent brightening agent and the photopolymerization initiator, LEDs having a light emission peak in a wavelength band of from 360 nm to 420 nm are usable. The wavelength of the LED is not limited to the wavelength in the case where a single LED is used; a plurality of LEDs may be used in combination so as for the light source to have a plurality of light emission peaks. For example, LEDs respectively having the peak wavelengths of 365 nm, 385 nm, 395 nm and 405 nm may be used in combinations of two or more thereof.

The fluorescent brightening agents may be used each alone or in combinations of two or more thereof. The fluorescent brightening agent is included preferably in a content of 0.01% by mass to 0.5% by mass in relation to the total mass (100% by mass) of the light curable aqueous emulsion. When the content falls within this range, the light curability is made satisfactory, and the effect of the fluorescent brightening agent itself possibly exerting on the hue of the cured film can be reduced.

### Preparation Method of Light Curable Aqueous Emulsion

As for the light curable aqueous emulsion of the present embodiment, a person having ordinary skill in the art may select appropriate methods by appropriately improving and modifying the methods performed in the below described examples; thus, heretofore known methods such as emulsion polymerization, high pressure emulsification and phase inversion emulsification may be adopted. Within the range not impairing the advantageous effects of the present invention, heretofore known various emulsifying agents and dispersing agents may also be used where necessary.

The emulsion polymerization is a method in which an amphiphilic substance such as a surfactant is added in the water phase, and then an oil phase is added to the water phase. The high pressure emulsification method is a method in which a water phase, an oil phase and an amphiphilic substance such as a surfactant are preliminarily mixed, and the resulting mixture is emulsified with a high pressure emulsifying machine such as a homogenizer to yield an aqueous emulsion. The inversion emulsification method is a method in which an amphiphilic substance such as a surfactant is dissolved or dispersed in an oil phase, and a water phase is added to the oil phase to yield an O/W type emulsion. The continuous phase is inverted from water to oil (inverse phase) midway through the emulsification, and hence this emulsification is referred to as the phase inversion emulsification. In this connection, the aforementioned surfactant is not limited to the following examples; however, examples of such a surfactant include: sodium alkylsulfonate, alkyl sulfate ester sodium, alkyl ether sulfate ester sodium, polyoxyethylene alkyl ether, polyoxyethylene alkyl phenyl ether, alkylamino fatty acid sodium salt and alkyl trimethyl ammonium salt.

When the light curable aqueous emulsion is prepared by using the aforementioned cross-linked urethane(meth)acrylate, either of the emulsion formation and the cross-linking reaction may come first. In particular, when the cross-linking reaction follows the establishment of the emulsified condition, gelification can be effectively prevented; hence, it is preferable to perform the cross-linking reaction in the emulsion condition following emulsification.

The counterpart of the cross-linking reaction based on the cross-linking agent is not limited to the urethane(meth)acrylate represented by the foregoing general formula (1), but may also be other included substances such as the aforementioned compound having in the molecule thereof three or more (meth)acryloyl groups.

As described above, the light curable aqueous emulsion according to the present embodiment using the urethane(meth)acrylate of the aforementioned embodiment can provide a light curable aqueous emulsion which is low in viscosity, excellent in curability, light curable in the presence of water, and additionally excellent in hydrolysis resistance. In particular, in the form in which the compound having a radical polymerizable group(s) and the photoradical polymerization initiator are included in the micelles formed by the urethane(meth)acrylate of the aforementioned embodiment, the concerned light curable aqueous emulsion can acquire the excellent curability and the performance of being light curable even in the presence of a predetermined concentration of water, wherein such performance is not found in conventional light curable aqueous emulsions. The urethane(meth)acrylate forming the micelles of the light curable aqueous emulsion of the present embodiment is capable of densely orienting due to the structure thereof, and further strong bonding force due to hydrogen bond probably operates between the arranged urethane(meth)acrylate molecules because the urethane(meth)acrylate has the urethane bonds (urethane groups) in the hydrophobic moiety in the structure thereof. Probably because of this, there has been obtained a stable emulsion in which the included substances in the micelles hardly leak and hydrolysis hardly occurs.

The reasons for the fact that the light curable aqueous emulsion of the present embodiment is excellent in photopolymerizability (curability) and additionally is polymerized (cured) with light even in the presence of a predetermined concentration of water are not yet clear; however, the reasons are inferred as follows. As described above, the light curable aqueous emulsion of the present embodiment takes the condition such that the urethane(meth)acrylate of the aforementioned embodiment forms in water spherical micelles including in the core thereof the compound having a radical polymerizable group(s) and the photoradical polymerization initiator; in this condition, light irradiation does not cause polymerization (curing). When the light curable aqueous emulsion is applied to a substrate and dried so as to have a predetermined concentration, light irradiation can cause polymerization (curing) even in the condition such that water remains, and thus a satisfactory adhesion to the substrate can be obtained. This is presumably because the decrease of the water concentration allows the spherical micelles to form a lamellar structure under the condition that the spherical micelles hold in the interior thereof the compound having a radical polymerizable group(s) and the photoradical polymerization initiator; and irradiation of the lamellar structure with light allows the photoradical polymerization initiator in the interior of the lamellar structure to be the initiator radical, and the initiator radical attacks the compound having a radical polymerizable group(s) and the acryloyl group of the urethane(meth)acrylate of the aforementioned embodiment to cause a chain reaction. This presumption is made for the purpose of describing the curability of the light curable aqueous emulsion of the present embodiment, but is not construed to limit the light curable aqueous emulsion of the present embodiment.

Production Method of Coating Film

An embodiment of the present invention relates to a production method of a coating film. The concerned production method includes an application step and a curing step. First, in the application step, the light curable aqueous emulsion of the aforementioned embodiment is used as a coating liquid, and the coating liquid is applied onto a substrate with a coating tool or a coating machine such as a bar coater. In this application, the application thickness is appropriately determined according to the intended use of the coating film.

Next, the curing step is a step in which the applied film formed in the coating step is cured by irradiating the applied film with light having a specific wavelength to form a coating film. By irradiating the applied film on a printing medium with light falling in a specific wavelength range, a light curing reaction (photoradical polymerization) is caused to produce a cured coating film. The light falling in a specific wavelength range is preferably ultraviolet (UV) light. The specific wavelength range (ultraviolet range) is preferably a range from 360 to 410 nm and more preferably a range from 380 to 400 nm. The wavelength range falling within the aforementioned range enables to obtain more excellent curability.

For example, mercury lamps and metal halide lamps are widely known as the light-emitting light sources falling in the aforementioned wavelength range. On the other hand, from the viewpoint of environmental protection, mercury-free light sources are strongly demanded; replacement of mercury lamps with ultraviolet light emitting devices of GaN-based semiconductor is proceeded. Light-emitting diodes (LEDs) and laser diodes (LDs) are small in size, high in efficiency and long in operating life, and hence are being used. Because of the aforementioned reasons, light-emitting diodes (LEDs) each having a peak wavelength in a range from 360 to 400 nm are preferable.

The aforementioned substrate is not particularly limited; however, examples of the substrate include: plastic substrates (plates, films and molded articles) made of polymers such as polyvinyl chloride (PVC), polyethylene, polypropylene and polyethylene terephthalate (PET); metal plates made of metals such as iron, silver, copper and aluminum; metal plates and plastic films prepared by vapor deposition of these various metals; plates made of alloys such as stainless steel and brass; and ceramics. High-quality paper and paper used in running on, and various paper media are also preferably usable.

The aforementioned coating liquid may include an additive such as a leveling agent according to the substrate. For example, as a silicone-based leveling agent, a polyester-modified silicone or a polyether-modified silicone can be used; in particular, it is preferable to use polyether-modified polydimethylsiloxane or polyester-modified polydimethylsiloxane. By using these, it is possible to prevent the repelling of the coating liquid on a substrate having liquid repellency such as a PVC substrate. Specific examples of the aforementioned silicone-based leveling agent may include: BYK-347, BYK-348, BYK-UV3500, 3510, 3530 and 3570 (manufactured by Byk-Chemie Japan Co., Ltd.).

The coating liquid in the present embodiment can be used for paints, coating agents, adhesives and the like.

### EXAMPLES

Hereinafter, the embodiments of the present invention are more specifically described with reference to Examples, but the embodiments of present invention are not limited only to these Examples.

Materials Used

Synthesis Materials for Urethane Acrylate

A: Hydroxyl Group-Containing Acrylates
Polypropylene glycol monoacrylate having a weight average molecular weight of 400 (trade name: Blenmer AP-400, manufactured by NOF Corp.) (hereinafter, referred to as “PPG acrylate”)
Pentaerythritol triacrylate (trade name: Aronix M-305, manufactured by Toagosei Co., Ltd.)
Dipentaerythritol pentaacrylate (trade name: Aronix M-403, manufactured by Toagosei Co., Ltd)

B: Diisocyanate
Isophorone diisocyanate (hereinafter, referred to as “IPDI”)

C: Diol of Acyclic Hydrocarbon or Alicyclic Hydrocarbon Having 6 to 20 Carbon Atoms
1,12-Dodecanediol
polypropylene glycol having a weight average molecular weight of 400 (trade name: Uniol D-400, manufactured by NOF Corp.)

D: Polyoxyalkylene Glycol Monoalkyl Ethers
Polyethylene glycol monomethyl ether having a weight average molecular weight of 400 (trade name: methoxy PEG 400, manufactured by Toho Chemical Industry Co., Ltd.) (hereinafter, referred to as “methoxy PEG 400”)
Polyethylene glycol monomethyl ether having a weight average molecular weight of 1000 (trade name: methoxy PEG 1000, manufactured by Toho Chemical Industry Co., Ltd.) (hereinafter, referred to as “methoxy PEG 1000”)
Polyethylene glycol monomethyl ether having a weight average molecular weight of 2000 (trade name: Uniox M-2000, manufactured by NOF Corp.) (hereinafter, also referred to as “methoxy PEG 2000”)

Synthesis Material for Cross-Linked Urethane Acrylate

In addition to the above-listed compounds, as a cross-linking agent, pentaerythritol tetrakis 3-mercaptopropionate (cross-linking thiol, hereinafter also referred to as “PEMP”) was used.

Compounds Having Radical Polymerizable Group(s)
Dipentaerythritol pentaacrylate, dipentaerythritol hexaacrylate (trade name: Aronix M-403, manufactured by Toagosei Co., Ltd., the content of dipentaerythritol pentaacrylate: 50 to 60% by mass)
Polypentaerythritol polyacrylate (trade name: Viscoat 802, manufactured by Osaka Organic Chemical Ind., Ltd.)
Dendrimer acrylate (trade name: Viscoat 1000, manufactured by Osaka Organic Chemical Ind., Ltd.)
Decafunctional urethane acrylate (trade name: KU-DPU, Arakawa Chemical Industries, Ltd.)
Urethane acrylate for fixing (for production method, see below-described Production Example 1)

Photoradical Polymerization Initiators
Acylphosphine oxide-based photopolymerization initiator (trade name: DAROCUR TPO, manufactured by BASF Corp.) (hereinafter, simply referred to as “TPO”)
Thioxanthone-based photopolymerization initiator (trade name: Speedcure DETX, manufactured by manufactured by Lambson Ltd.) (hereinafter, simply referred to as “DETX”)

Fluorescent Brightening Agent
1,4-Bis(2-benzoxazolyl)naphthalene (trade name: HOSTALUX KCB, manufactured by Clariant (Japan) K.K.) (hereinafter, simply referred to as “KCB”)

Leveling Agent
Polyether-modified organosiloxane (trade name: BYK-348, manufactured by Byk-Chemie Japan Co., Ltd.)

Structure and Synthesis of Urethane Acrylates

Structure of Urethane Acrylates

The urethane acrylates used in following Examples and Comparative Examples are the urethane acrylates having respectively the structures represented by the foregoing general formula (1) and the following general formulas (3), (4) and (5):

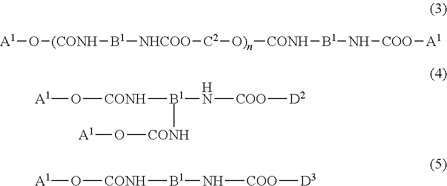

wherein A¹ represents a structure derived from a hydroxyl group-containing acrylate having one or more acryloyl groups, B¹ represents a structure derived from diisocyanate, C² represents a structure derived from diol, and D² and D³ each represent a structure derived from a polyoxyethylene glycol with one terminal thereof blocked with a methyl group (hereinafter, also referred to as polyoxyethylene glycol monomethyl ether), of the compounds represented by the foregoing general formula (2).

### Synthesis of Amphiphilic Urethane Acrylates

### Example 1

### Synthesis of Amphiphilic Urethane Acrylate (a)

In a reaction vessel equipped with a stirrer, a condenser tube, a dropping funnel and an air introduction tube, 444.6 parts by mass of IPDI and 202.3 parts by mass of 1,12-dodecanediol were placed, and while the resulting mixture was being stirred, 0.26 part by mass of tin octylate was added to the mixture, the temperature inside the reaction vessel was increased to 90° C., and the resulting mixture was allowed to react for 1.5 hours. Then, 200.0 parts by mass of methoxy PEG 400, 200.0 parts by mass of methoxy PEG 1000 and 0.42 part by mass of tin octylate were added to the reaction mixture, and the resulting mixture was allowed to react further for 1.5 hours. Next, in the reaction vessel, 634.3 parts by mass of PPG acrylate, 0.84 part by mass of methoquinone (hydroquinone monomethyl ether) and 0.67 part by mass of tin octylate were placed and mixed, and under air bubbling, the temperature inside the reaction vessel was increased to 85° C. and the resulting mixture was allowed to react for 3 hours. Then, the reaction mixture was cooled to yield the amphiphilic urethane acrylate (a) represented by the foregoing general formula (1). The weight average molecular weight of the urethane acrylate (a) was found to be 3,200.

### Example 2

### Synthesis of Amphiphilic Urethane Acrylate (b)

In the same reaction vessel as in Example 1, 444.6 parts by mass of IPDI and 202.3 parts by mass of 1,12-dodecanediol were placed, and while the resulting mixture was being stirred, 0.26 part by mass of tin octylate was added to the mixture, the temperature inside the reaction vessel was increased to 90° C., and the resulting mixture was allowed to react for 1.5 hours. Then, 200.0 parts by mass of methoxy PEG 400, 200.0 parts by mass of methoxy PEG 1000 and 0.42 part by mass of tin octylate were added to the reaction mixture, and the resulting mixture was allowed to react further for 1.5 hours. Next, in the reaction vessel, 594.4 parts by mass of pentaerythritol triacrylate, 0.82 part by mass of methoquinone and 0.66 part by mass of tin octylate were placed and mixed, and under air bubbling, the temperature inside the reaction vessel was increased to 85° C. and the resulting mixture was allowed to react for 3 hours. Then, the reaction mixture was cooled to yield the amphiphilic urethane acrylate (b) represented by the foregoing general formula (1). The weight average molecular weight of the urethane acrylate (b) was found to be 3,800.

### Example 3

### Synthesis of Amphiphilic Urethane Acrylate (c)

In the same reaction vessel as in Example 1, 444.6 parts by mass of IPDI and 202.3 parts by mass of 1,12-dodecanediol were placed, and while the resulting mixture was being stirred, 0.26 part by mass of tin octylate was added to the mixture, the temperature inside the reaction vessel was increased to 90° C., and the resulting mixture was allowed to react for 1.5 hours. Then, 200.0 parts by mass of methoxy PEG 400, 200.0 parts by mass of methoxy PEG 1000 and 0.42 part by mass of tin octylate were added to the reaction mixture, and the resulting mixture was allowed to react further for 1.5 hours. Next, in the reaction vessel, 1300.0 parts by mass of dipentaerythritol pentaacrylate, 1.17 parts by mass of methoquinone and 0.94 part by mass of tin octylate were placed and mixed, and under air bubbling, the temperature inside the reaction vessel was increased to 85° C. and the resulting mixture was allowed to react for 3 hours. Then, the reaction mixture was cooled to yield the amphiphilic urethane acrylate (c) represented by the foregoing general formula (1). The weight average molecular weight of the urethane acrylate (c) was found to be 5,300.

### Example 4

### Synthesis of Amphiphilic Urethane Acrylate (d)

In the same reaction vessel as in Example 1, 444.6 parts by mass of IPDI and 202.3 parts by mass of 1,12-dodecanediol were placed, and while the resulting mixture was being stirred, 0.26 part by mass of tin octylate was added to the mixture, the temperature inside the reaction vessel was increased to 90° C., and the resulting mixture was allowed to react for 1.5 hours. Then, 700.0 parts by mass of methoxy PEG 1000 and 0.54 part by mass of tin octylate were added to the reaction mixture, and the resulting mixture was allowed to react further for 1.5 hours. Next, in the reaction vessel, 1300.0 parts by mass of dipentaerythritol pentaacrylate, 1.32 parts by mass of methoquinone and 1.06 parts by mass of tin octylate were placed and mixed, and under air bubbling, the temperature inside the reaction vessel was increased to 85° C. and the resulting mixture was allowed to react for 3 hours. Then, the reaction mixture was cooled to yield the amphiphilic urethane acrylate (d) represented by the foregoing general formula (1). The weight average molecular weight of the urethane acrylate (d) was found to be 5,600.

### Example X

### Synthesis of Amphiphilic Urethane Acrylate (e)

In the same reaction vessel as in Example 1, 444.6 parts by mass (2 moles) of IPDI and 400.0 parts by mass of polypropylene glycol having a weight average molecular weight of 400 were placed, and while the resulting mixture was being stirred, 0.34 part by mass of tin octylate was added to the mixture, the temperature inside the reaction vessel was increased to 90° C., and the resulting mixture was allowed to react for 1.5 hours. Then, 1400.0 parts by mass of methoxy PEG 2000 and 0.90 part by mass of tin octylate were added to the reaction mixture, and the resulting mixture was allowed to react further for 1.5 hours. Next, in the reaction vessel, 1300.0 parts by mass of dipentaerythritol pentaacrylate, 1.77 parts by mass of methoquinone and 2.13 parts by mass of tin octylate were placed and mixed, and under air bubbling, the temperature inside the reaction vessel was increased to 85° C. and the resulting mixture was allowed to react for 3 hours. Then, the reaction mixture was cooled to yield the amphiphilic urethane acrylate (e) represented by the foregoing general formula (1). The weight average molecular weight of the urethane acrylate (e) was found to be 9,000.

### Comparative Example 1

### Synthesis of Urethane Acrylate (p)

In the same reaction vessel as in Example 1, 444.6 parts by mass of IPDI and 1000.0 parts by mass of polyethylene glycol (PEG 1000, manufactured by NOF Corp.) were placed, and while the resulting mixture was being stirred, 0.58 part by mass of tin octylate was added to the mixture, the temperature inside the reaction vessel was increased to 90° C., and the resulting mixture was allowed to react for 1.5 hours. Then, 2400.0 parts by mass of dipentaerythritol pentaacrylate, 1.92 parts by mass of methoquinone and 1.54 parts by mass of tin octylate were placed in the reaction vessel and mixed, and under air bubbling, the temperature inside the reaction vessel was increased to 85° C. and the resulting mixture was allowed to react for 3 hours. Then, the reaction mixture was cooled to yield the urethane acrylate (p). The urethane acrylate (p) is a urethane acrylate in which both terminal groups are each an acryloyl group, and is represented by the foregoing general formula (3). The weight average molecular weight of the urethane acrylate (p) was found to be 10,500.

### Comparative Example 2

### Synthesis of Urethane Acrylate (q)

In the same reaction vessel as in Example 1, 578.0 parts by mass of the trimer of HMDI (coronate HXR, manufactured by Nippon Polyurethane Industry Co., Ltd.), 200.0 parts by mass of methoxy PEG 400 and 200.0 parts by mass of methoxy PEG 1000 were placed, and while the resulting mixture was being stirred, 0.39 part by mass of tin octylate was added to the mixture, the temperature inside the reaction vessel was increased to 75° C., and the resulting mixture was allowed to react for 1.5 hours. Then, 1051.6 parts by mass of pentaerythritol triacrylate, 1.01 parts by mass of methoquinone and 0.81 part by mass of tin octylate were placed in the reaction vessel and mixed, and under air bubbling, the temperature inside the reaction vessel was increased to 80° C. and the resulting mixture was allowed to react for 2 hours. Then, the reaction mixture was cooled to yield the amphiphilic urethane acrylate (q). The urethane acrylate (q) is a urethane acrylate in which one terminal group is an acryloyl group and for which a trifunctional isocyanate was used, and is represented by the foregoing general formula (4). The weight average molecular weight of the urethane acrylate (q) was found to be 7,400.

### Comparative Example 3

### Synthesis of Urethane Acrylate (s)

In the same reaction vessel as in Example 1, 444.6 parts by mass of IPDI and 62.1 parts by mass of ethylene glycol were placed, and while the resulting mixture was being stirred, 0.20 part by mass of tin octylate was added to the mixture, the temperature inside the reaction vessel was increased to 90° C., and the resulting mixture was allowed to react for 1.5 hours. Then, 700.0 parts by mass of methoxy PEG 1000 and 0.48 part by mass of tin octylate were added to the reaction mixture, and the resulting mixture was allowed to react further for 1.5 hours. Then, 634.3 parts by mass of PPG acrylate, 0.92 parts by mass of methoquinone and 0.68 part by mass of tin octylate were placed in the reaction vessel and mixed, and under air bubbling, the temperature inside the reaction vessel was increased to 85° C. and the resulting mixture was allowed to react for 3 hours. Then, the reaction mixture was cooled to yield the urethane acrylate (s) having a structure analogous to the structure represented by the foregoing general formula (1). Specifically, the urethane acrylate (s) has a structure analogous to the structure represented by the foregoing general formula (1) in the sense that the urethane acrylate (s) is a urethane acrylate in which the number of carbon atoms in “C¹” in the foregoing general formula (1) is 2, but the urethane acrylate (s) does not have the structure itself represented by the general formula (1). The weight average molecular weight of the urethane acrylate (s) was found to be 3,000.

### Comparative Example 4

### Synthesis of Urethane Acrylate (t)

In the same reaction vessel as in Example 1, 222.3 parts by mass of IPDI and 700.0 parts by mass of methoxy PEG 1000 were placed, and while the resulting mixture was being stirred, 0.48 part by mass of tin octylate was added to the mixture, the temperature inside the reaction vessel was increased to 90° C., and the resulting mixture was allowed to react for 1.5 hours. Then, 634.3 parts by mass of PPG acrylate, 0.78 part by mass of methoquinone and 0.62 part by mass of tin octylate were added in the reaction vessel and mixed, and under air bubbling, the temperature inside the reaction vessel was increased to 85° C. and the resulting mixture was allowed to react for 3 hours. Then, the reaction mixture was cooled to yield the urethane acrylate (t) represented by the foregoing general formula (5). The urethane acrylate (t) is a urethane acrylate free from diol residues. The weight average molecular weight of the urethane acrylate (t) was found to be 2,300.

### Production Example 1

### Synthesis of Urethane Acrylate for Fixing

In the same reaction vessel as in Example 1, 444.6 parts by mass (2 moles) of IPDI and 900.0 parts by mass (1 mole) of an aromatic polyester diol (weight average molecular weight: 900, trade name: YG-108, manufactured by Adeka Corp.) were placed, and while the resulting mixture was being stirred, 0.27 part by mass of tin octylate was added to the mixture, the temperature inside the reaction vessel was increased to 85° C., and the resulting mixture was allowed to react for 2 hours. Then, 232.3 parts by mass (2 moles) of 2-hydroxyethyl acrylate, 0.79 part by mass of methoquinone and 0.63 part by mass of tin octylate were placed in the reaction vessel and mixed, and under air bubbling, the temperature inside the reaction vessel was increased to 85° C. and the resulting mixture was allowed to react for 2 hours. Then, the reaction mixture was cooled to yield the urethane acrylate. The weight average molecular weight of the urethane acrylate was found to be 5,000.

Preparation of Light Curable Aqueous Emulsions

Hereinafter, the preparation methods of light curable aqueous emulsions are described.

### Example 5

### Preparation of a Light Curable Aqueous Emulsion (b-1)

In the same reaction vessel as in Example 1, 36.7 parts by mass of the amphiphilic urethane acrylate (b) obtained above and 3.3 parts by mass of a photoradical polymerization initiator (TPO) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 60 parts by mass of deionized water was added to the mixture, and the mixture was maintained at 40° C. for 1 hour to yield the light curable aqueous emulsion (b-1) containing 40% of a nonvolatile content (the amphiphilic urethane acrylate (b) and the photoradical polymerization initiator (TPO)) (see Table 1).

### Example 6

### Preparation of a Light Curable Aqueous Emulsion (c-1)

In the same reaction vessel as in Example 1, 36.7 parts by mass of the amphiphilic urethane acrylate (c) obtained above and 3.3 parts by mass of a photoradical polymerization initiator (TPO) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 60 parts by mass of deionized water was added to the mixture, and the mixture was maintained at 40° C. for 1 hour to yield the light curable aqueous emulsion (c-1) containing 40% of a nonvolatile content (the amphiphilic urethane acrylate (c) and the photoradical polymerization initiator (TPO)) (see Table 1).

### Example 7

### Preparation of a Light Curable Aqueous Emulsion (a-1)

In the same reaction vessel as in Example 1, 28.5 parts by mass of the amphiphilic urethane acrylate (a) obtained above, 9.5 parts by mass of dipentaerythritol pentaacrylate and 2.0 parts by mass of a photoradical polymerization initiator (TPO) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 60 parts by mass of deionized water was added to the mixture, and the mixture was maintained at 40° C. for 1 hour to yield the light curable aqueous emulsion (a-1) containing 40% of a nonvolatile content (the amphiphilic urethane acrylate (a), dipentaerythritol pentaacrylate and the photoradical polymerization initiator (TPO)) (see Table 2).

### Example 8

### Preparation of a Light Curable Aqueous Emulsion (d-1)

In the same reaction vessel as in Example 1, 27.5 parts by mass of the amphiphilic urethane acrylate (d) obtained above, 9.2 parts by mass of dipentaerythritol hexaacrylate and 3.3 parts by mass of a photoradical polymerization initiator (TPO) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 60 parts by mass of deionized water was added to the mixture, and the mixture was maintained at 40° C. for 1 hour to yield the light curable aqueous emulsion (d-1) containing 40% of a nonvolatile content (the amphiphilic urethane acrylate (d), dipentaerythritol diacrylate and the photoradical polymerization initiator (TPO)) (see Table 2).

### Example 9

### Preparation of a Light Curable Aqueous Emulsion (d-2)

In the same reaction vessel as in Example 1, 27.5 parts by mass of the amphiphilic urethane acrylate (d) obtained above, 9.2 parts by mass of polypentaerythritol polyacrylate and 3.3 parts by mass of a photoradical polymerization initiator (TPO) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 60 parts by mass of deionized water was added to the mixture, and the mixture was maintained at 40° C. for 1 hour to yield the light curable aqueous emulsion (d-2) containing 40% of a nonvolatile content (the amphiphilic urethane acrylate (d), polypentaerythritol polyacrylate and the photoradical polymerization initiator (TPO)) (see Table 2).

### Example 10

### Preparation of a Light Curable Aqueous Emulsion (d-3)

In the same reaction vessel as in Example 1, 27.5 parts by mass of the amphiphilic urethane acrylate (d) obtained above, 9.2 parts by mass of dendrimer acrylate and 3.3 parts by mass of a photoradical polymerization initiator (TPO) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 60 parts by mass of deionized water was added to the mixture, and the mixture was maintained at 40° C. for 1 hour to yield the light curable aqueous emulsion (d-3) containing 40% of a nonvolatile content (the amphiphilic urethane acrylate (d), dendrimer acrylate and the photoradical polymerization initiator (TPO)) (see Table 2).

### Example 11

### Preparation of a Light Curable Aqueous Emulsion (d-4)

In the same reaction vessel as in Example 1, 27.5 parts by mass of the amphiphilic urethane acrylate (d) obtained above, 9.2 parts by mass of decafunctional urethane acrylate and 3.3 parts by mass of a photoradical polymerization initiator (TPO) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 60 parts by mass of deionized water was added to the mixture, and the mixture was maintained at 40° C. for 1 hour to yield the light curable aqueous emulsion (d-4) containing 40% of a nonvolatile content (the amphiphilic urethane acrylate (d), decafunctional urethane polyacrylate and the photoradical polymerization initiator (TPO)) (see Table 2).

### Example 12

### Preparation of a Light Curable Aqueous Emulsion (d-2-1)

The light curable aqueous emulsion (d-2-1) for the evaluation test was obtained by adding 0.1 part by mass of BYK 348 and 69.9 parts by mass of deionized water to 30 parts by mass of the light curable aqueous emulsion (d-2) containing 40% of a nonvolatile content obtained in aforementioned Example 9 (see Table 6).

### Example 13

### Preparation of a Light Curable Aqueous Emulsion (d-5-1)

In the same reaction vessel as in Example 1, 27.4 parts by mass of the amphiphilic urethane acrylate (d) obtained above, 9.1 parts by mass of polypentaerythritol polyacrylate, 3.3 parts by mass of a photoradical polymerization initiator (TPO) and 0.13 part by mass of a fluorescent brightening agent (KCB) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 60 parts by mass of deionized water was added to the mixture, and the mixture was maintained at 40° C. for 1 hour to yield the light curable aqueous emulsion (d-5) containing 40% of a nonvolatile content (the amphiphilic urethane acrylate (d), polypentaerythritol polyacrylate, the photoradical polymerization initiator (TPO) and the fluorescent brightening agent (KCB)) (for the foregoing, see Table 5). The light curable aqueous emulsion (d-5-1) for the evaluation test was obtained by adding 0.1 part by mass of BYK 348 and 69.9 parts by mass of deionized water to 30 parts by mass of the light curable aqueous emulsion (d-5) containing 40% of a nonvolatile content (for the foregoing, see Table 6).

### Example 14

### Preparation of a Light Curable Aqueous Emulsion (d-6-1)

In the same reaction vessel as in Example 1, 26.2 parts by mass of the amphiphilic urethane acrylate (d) obtained above, 8.7 parts by mass of polypentaerythritol polyacrylate and 3.3 parts by mass of a photoradical polymerization initiator (TPO) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 1.7 parts by mass of a cross-linking agent (PEMP) was added to the mixture, and the mixture was continuously stirred as it was for 15 minutes. Then, 60 parts by mass of deionized water was added to the mixture, the mixture was maintained at 50° C. for 1 hour, then the temperature inside the vessel was increased to 80° C., and the mixture was maintained at 80° C. for 6 hours to yield the light curable aqueous emulsion (d-6) containing 40% of a nonvolatile content (the amphiphilic urethane acrylate (d), polypentaerythritol polyacrylate, the photoradical polymerization initiator (TPO) and the cross-linking agent (PEMP)). The emulsion was subjected to a GPC measurement to identify a cross-linked urethane acrylate having a weight average molecular weight of 8,500 (for the foregoing, see Table 5).

The light curable aqueous emulsion (d-6-1) for the evaluation test was obtained by adding 0.1 part by mass of BYK 348 and 69.9 parts by mass of deionized water to 30 parts by mass of the light curable aqueous emulsion (d-6) containing 40% of a nonvolatile content (for the foregoing, see Table 6).

### Example 15

### Preparation of a Light Curable Aqueous Emulsion (d-7-1)

In the same reaction vessel as in Example 1, 26.1 parts by mass of the amphiphilic urethane acrylate (d) obtained above, 8.7 parts by mass of polypentaerythritol polyacrylate, 3.3 parts by mass of a photoradical polymerization initiator (TPO) and 0.07 part by mass of a fluorescent brightening agent (KCB) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 1.7 parts by mass of a cross-linking agent (PEMP) was added to the mixture, and the mixture was continuously stirred as it was for 15 minutes. Then, 60 parts by mass of deionized water was added to the mixture, the mixture was maintained at 50° C. for 1 hour, then the temperature inside the vessel was increased to 80° C., and the mixture was maintained at 80° C. for 6 hours to yield the light curable aqueous emulsion (d-7) containing 40% of a nonvolatile content (the amphiphilic urethane acrylate (d), polypentaerythritol polyacrylate, the photoradical polymerization initiator (TPO), the fluorescent brightening agent (KCB) and the cross-linking agent (PEMP)). The emulsion was subjected to a GPC measurement to identify a cross-linked urethane acrylate having a weight average molecular weight of 16,000 (for the foregoing, see Table 5).

The light curable aqueous emulsion (d-7-1) for the evaluation test was obtained by adding 0.1 part by mass of BYK 348 and 69.9 parts by mass of deionized water to 30 parts by mass of the light curable aqueous emulsion (d-7) containing 40% of a nonvolatile content (for the foregoing, see Table 6).

### Example 16

### Preparation of a Light Curable Aqueous Emulsion (e-1-1)

In the same reaction vessel as in Example 1, 23.3 parts by mass of the amphiphilic urethane acrylate (e) obtained above, 8.3 parts by mass of polypentaerythritol polyacrylate, 1.7 parts by mass of the urethane acrylate for fixing, 5.0 parts by mass of a photoradical polymerization initiator (TPO), 1.7 parts by mass of a photoradical polymerization initiator (DETX) and 0.07 part by mass of a fluorescent brightening agent (KCB) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 60 parts by mass of deionized water was added to the mixture, and the mixture was maintained at 50° C. for 1 hour to yield the light curable aqueous emulsion (e-1) containing 40% of a nonvolatile content (the amphiphilic urethane acrylate (e), polypentaerythritol polyacrylate, the urethane acrylate for fixing, the photoradical polymerization initiators (TPO, DETX) and the fluorescent brightening agent (KCB)) (for the foregoing, see Table 5).

The light curable aqueous emulsion (e-1-1) for the evaluation test was obtained by adding 0.1 part by mass of BYK 348 and 69.9 parts by mass of deionized water to 30 parts by mass of the light curable aqueous emulsion (e-1) containing 40% of a nonvolatile content (for the foregoing, see Table 6).

### Example 17

### Preparation of a Light Curable Aqueous Emulsion (e-2-1)

In the same reaction vessel as in Example 1, 23.9 parts by mass of the amphiphilic urethane acrylate (e) obtained above, 10.3 parts by mass of polypentaerythritol polyacrylate, 3.3 parts by mass of a photoradical polymerization initiator (TPO) and 0.07 part by mass of a fluorescent brightening agent (KCB) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 2.4 parts by mass of a cross-linking agent (PEMP) was added to the mixture, and the mixture was continuously stirred as it was for 15 minutes. Then, 60 parts by mass of deionized water was added to the mixture, the mixture was maintained at 50° C. for 1 hour, then the temperature inside the vessel was increased to 80° C., and the mixture was maintained at 80° C. for 6 hours to yield the light curable aqueous emulsion (e-2) containing 40% of a nonvolatile content (the amphiphilic urethane acrylate (e), polypentaerythritol polyacrylate, the photoradical polymerization initiator (TPO), the fluorescent brightening agent (KCB) and the cross-linking agent (PEMP)). The emulsion was subjected to a GPC measurement to identify a cross-linked urethane acrylate having a weight average molecular weight of 20,000 (for the foregoing, see Table 5).

The light curable aqueous emulsion (e-2-1) for the evaluation test was obtained by adding 0.1 part by mass of BYK 348 and 69.9 parts by mass of deionized water to 30 parts by mass of the light curable aqueous emulsion (e-2) containing 40% of a nonvolatile content (for the foregoing, see Table 6).

### Example 18

### Preparation of a Light Curable Aqueous Emulsion (e-3-1)

In the same reaction vessel as in Example 1, 21.6 parts by mass of the amphiphilic urethane acrylate (e) obtained above, 9.2 parts by mass of polypentaerythritol polyacrylate, 6.7 parts by mass of a photoradical polymerization initiator (TPO) and 0.06 part by mass of a fluorescent brightening agent (KCB) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 2.5 parts by mass of a cross-linking agent (PEMP) was added to the mixture, and the mixture was continuously stirred as it was for 15 minutes. Then, 60 parts by mass of deionized water was added to the mixture, the mixture was maintained at 50° C. for 1 hour, then the temperature inside the vessel was increased to 80° C., and the mixture was maintained at 80° C. for 6 hours to yield the light curable aqueous emulsion (e-3) containing 40% of a nonvolatile content (the amphiphilic urethane acrylate (e), polypentaerythritol polyacrylate, the photoradical polymerization initiator (TPO), the fluorescent brightening agent (KCB) and the cross-linking agent (PEMP)). The emulsion was subjected to a GPC measurement to identify a cross-linked urethane acrylate having a weight average molecular weight of 22,000 (for the foregoing, see Table 5).

The light curable aqueous emulsion (e-3-1) for the evaluation test was obtained by adding 0.1 part by mass of BYK 348 and 69.9 parts by mass of deionized water to 30 parts by mass of the light curable aqueous emulsion (e-3) containing 40% of a nonvolatile content (for the foregoing, see Table 6).

### Example 19

### Preparation of a Light Curable Aqueous Emulsion (e-4-1)

In the same reaction vessel as in Example 1, 21.6 parts by mass of the amphiphilic urethane acrylate (e) obtained above, 9.2 parts by mass of polypentaerythritol polyacrylate, 5.0 parts by mass of a photoradical polymerization initiator (TPO), 1.7 parts by mass of a photoradical polymerization initiator (DETX) and 0.06 part by mass of a fluorescent brightening agent (KCB) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 2.5 parts by mass of a cross-linking agent (PEMP) was added to the mixture, and the mixture was continuously stirred as it was for 15 minutes. Then, 60 parts by mass of deionized water was added to the mixture, the mixture was maintained at 50° C. for 1 hour, then the temperature inside the vessel was increased to 80° C., and the mixture was maintained at 80° C. for 6 hours to yield the light curable aqueous emulsion (e-4) containing 40% of a nonvolatile content (the amphiphilic urethane acrylate (e), polypentaerythritol polyacrylate, the photoradical polymerization initiators (TPO, DETX), the fluorescent brightening agent (KCB) and the cross-linking agent (PEMP)). The emulsion was subjected to a GPC measurement to identify a cross-linked urethane acrylate having a weight average molecular weight of 22,000 (for the foregoing, see Table 5).

The light curable aqueous emulsion (e-4-1) for the evaluation test was obtained by adding 0.1 part by mass of BYK 348 and 69.9 parts by mass of deionized water to 30 parts by mass of the light curable aqueous emulsion (e-4) containing 40% of a nonvolatile content (for the foregoing, see Table 6).

### Example 20

### Preparation of a Light Curable Aqueous Emulsion (e-5-1)

In the same reaction vessel as in Example 1, 21.6 parts by mass of the amphiphilic urethane acrylate (e) obtained above, 7.7 parts by mass of polypentaerythritol polyacrylate, 1.5 parts by mass of the urethane acrylate for fixing, 5.0 parts by mass of a photoradical polymerization initiator (TPO) and 1.7 parts by mass of a photoradical polymerization initiator (DETX) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 2.5 parts by mass of a cross-linking agent (PEMP) was added to the mixture, and the mixture was continuously stirred as it was for 15 minutes. Then, 60 parts by mass of deionized water was added to the mixture, the mixture was maintained at 50° C. for 1 hour, then the temperature inside the vessel was increased to 80° C., and the mixture was maintained at 80° C. for 6 hours to yield the light curable aqueous emulsion (e-5) containing 40% of a nonvolatile content (the amphiphilic urethane acrylate (e), polypentaerythritol polyacrylate, the urethane acrylate for fixing, the photoradical polymerization initiators (TPO, DETX) and the cross-linking agent (PEMP)). The emulsion was subjected to a GPC measurement to identify a cross-linked urethane acrylate having a weight average molecular weight of 18,000 (for the foregoing, see Table 5).

The light curable aqueous emulsion (e-5-1) for the evaluation test was obtained by adding 0.1 part by mass of BYK 348 and 69.9 parts by mass of deionized water to 30 parts by mass of the light curable aqueous emulsion (e-5) containing 40% of a nonvolatile content (for the foregoing, see Table 6).

### Example 21

### Preparation of a Light Curable Aqueous Emulsion (e-6-1)

In the same reaction vessel as in Example 1, 21.6 parts by mass of the amphiphilic urethane acrylate (e) obtained above, 7.7 parts by mass of polypentaerythritol polyacrylate, 1.5 parts by mass of the urethane acrylate for fixing, 5.0 parts by mass of a photoradical polymerization initiator (TPO), 1.7 parts by mass of a photoradical polymerization initiator (DETX) and 0.06 part by mass of a fluorescent brightening agent (KCB) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 2.5 parts by mass of a cross-linking agent (PEMP) was added to the mixture, and the mixture was continuously stirred as it was for 15 minutes. Then, 60 parts by mass of deionized water was added to the mixture, the mixture was maintained at 50° C. for 1 hour, then the temperature inside the vessel was increased to 80° C., and the mixture was maintained at 80° C. for 6 hours to yield the light curable aqueous emulsion (e-6) containing 40% of a nonvolatile content (the amphiphilic urethane acrylate (e), polypentaerythritol polyacrylate, the urethane acrylate for fixing, the photoradical polymerization initiators (TPO, DETX), the fluorescent brightening agent (KCB) and the cross-linking agent (PEMP)). The emulsion was subjected to a GPC measurement to identify a cross-linked urethane acrylate having a weight average molecular weight of 18,000 (for the foregoing, see Table 5).

The light curable aqueous emulsion (e-6-1) for the evaluation test was obtained by adding 0.1 part by mass of BYK 348 and 69.9 parts by mass of deionized water to 30 parts by mass of the light curable aqueous emulsion (e-6) containing 40% of a nonvolatile content (for the foregoing, see Table 6).

### Comparative Example 5

### Preparation of a Light Curable Aqueous Emulsion (p-1)

In the same reaction vessel as in Example 1, 38.0 parts by mass of the urethane acrylate (p) obtained above and 2.0 parts by mass of a photoradical polymerization initiator (TPO) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 60 parts by mass of deionized water was added to the mixture, and the mixture was maintained at 40° C. for 1 hour to yield the light curable aqueous emulsion (p-1) containing 40% of a nonvolatile content (the urethane acrylate (p) and the photoradical polymerization initiator (TPO)) (see Table 3).

### Comparative Example 6

### Preparation of a Light Curable Aqueous Emulsion (q-1)

In the same reaction vessel as in Example 1, 38.0 parts by mass of the urethane acrylate (q) obtained above and 2.0 parts by mass of a photoradical polymerization initiator (TPO) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 60 parts by mass of deionized water was added to the mixture, and the mixture was maintained at 40° C. for 1 hour to yield the light curable aqueous emulsion (q-1) containing 40% of a nonvolatile content (the urethane acrylate (q) and the photoradical polymerization initiator (TPO)) (see Table 3).

### Comparative Example 7

### Preparation of a Light Curable Aqueous Emulsion (q-2)

In the same reaction vessel as in Example 1, 27.5 parts by mass of the urethane acrylate (q) obtained above, 9.2 parts by mass of polypentaerythritol polyacrylate and 3.3 parts by mass of a photoradical polymerization initiator (TPO) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 60 parts by mass of deionized water was added to the mixture, and the mixture was maintained at 40° C. for 1 hour to yield the light curable aqueous emulsion (q-2) containing 40% of a nonvolatile content (the urethane acrylate (q), polypentaerythritol polyacrylate and the photoradical polymerization initiator (TPO)) (see Table 3).

### Comparative Example 8

### Preparation of a Light Curable Aqueous Emulsion (s-1)

In the same reaction vessel as in Example 1, 38.0 parts by mass of the urethane acrylate (s) obtained above and 2.0 parts by mass of a photoradical polymerization initiator (TPO) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 60 parts by mass of deionized water was added to the mixture, and the mixture was maintained at 40° C. for 1 hour to yield the light curable aqueous emulsion (s-1) containing 40% of a nonvolatile content (the urethane acrylate (s) and the photoradical polymerization initiator (TPO)) (see Table 3).

### Comparative Example 9

### Preparation of a Light Curable Aqueous Emulsion (t-1)

In the same reaction vessel as in Example 1, 38.0 parts by mass of the urethane acrylate (t) obtained above and 2.0 parts by mass of a photoradical polymerization initiator (TPO) were placed, and while the resulting mixture was being mixed, the temperature inside the vessel was increased to 80° C. and maintained at 80° C. for 2 hours. Next, the temperature inside the vessel was cooled to 50° C., and then, while the mixture was being stirred, 60 parts by mass of deionized water was added to the mixture, and the mixture was maintained at 40° C. for 1 hour to yield the light curable aqueous emulsion (t-1) containing 40% of a nonvolatile content (the urethane acrylate (t) and the photoradical polymerization initiator (TPO)) (see Table 3).

Evaluation Items

Emulsifiability

Each of the light curable aqueous emulsions prepared in the aforementioned “Preparation of Light Curable Aqueous Emulsions” was allowed to stand still at 40° C., and the condition variation of the emulsion was observed. The observation results were classified according to the following evaluation standards. The evaluation results are shown in Tables 2, 3 and 6.

A: Even when the emulsion was allowed to stand for one week or more, no occurrence of phase separation and precipitation was found without any variation from the initial condition.

B: When the emulsion was allowed to stand for one week, the occurrence of phase separation or precipitation was found.

C: Immediately after the preparation of the emulsion, the occurrence of phase separation or precipitation was found.

The concerned evaluation targeting at the light curable aqueous emulsion is equivalent to the evaluation of the emulsifiability of the urethane acrylate used in the light curable aqueous emulsion.

Viscosity

Each of the light curable aqueous emulsions prepared in the aforementioned “Preparation of Light Curable Aqueous Emulsions” was subjected to viscosity measurement with an E-type viscometer (trade name: TVE-20H, manufactured by Tokisangyo Co., Ltd.) under the condition that the temperature of the light curable aqueous emulsion was set at 25° C.

Curability in Each of Examples 5 to 11 and Comparative Examples 5 to 9

Each of the aforementioned light curable aqueous emulsions of Examples 5 to 11 and Comparative Examples 5 to 9 was applied onto a surface-treated PET film with a bar coater so as for the application thickness to be 10 μm; after an elapsed time of 120 seconds under the conditions of a temperature of 25° C. and a humidity of 40%, the applied emulsion layer was irradiated with ultraviolet light by using an LED lamp (395 nm, 1000 mW/m²) and then the cured condition was examined. The examination of the cured condition was performed as follows: the tip of a cotton swab was brought into contact with the coating surface, and when the cotton swab was moved under the conditions that the cotton swab was pressed against the coating surface with a pressure of 200 gf/cm² while the cotton swab was being inclined by 45 degrees from the coating surface, the case where no scratch was formed on the coating film was defined as the case where curing was achieved.
Application conditions: Bar coater No. 6 (film thickness under dried condition: 4 to 6 μm)

The evaluation results are shown in Tables 1 to 3.

Curability in Each of Examples 12 to 21

Each of the light curable aqueous emulsions (of these emulsions, the emulsions of Examples 13 to 21 are of a cross-linked type) shown in Table 5 was evaluated as follows for the purpose of making clear the evaluation results of the curability.

First, the light curable aqueous emulsion of aforementioned Example 9 (see Table 5) was diluted with water as shown in Table 6 in such a way that the irradiation energy amount required for curing was 30 mJ/cm² to 1,900 mJ/cm².

Next, this light curable aqueous emulsion of Example 9 and the light curable aqueous emulsions, each using a cross-linked urethane acrylate, of Examples 13 to 21 shown in Table 6 were evaluated with respect to curability in the same manner as described above except that a PVC film was adopted as the substrate, the coating condition involved a bar coater No. 9, the ultraviolet light irradiation was performed after an elapsed time of 90 seconds and the following evaluation standards were adopted.

AA: Less than 500 mJ/cm²

A: 500 mJ/cm² or more and less than 1000 mJ/cm²

B: 1000 mJ/cm² or more and less than 1500 mJ/cm²

C: 1500 mJ/cm² or more and less than 2000 mJ/cm²

D: 2000 mJ/cm² or more

The evaluation results are shown in Table 6.

Hydrolyzability

In a 70 mL glass sample bottle, each of the light curable aqueous emulsions of Examples 9 and 11 was placed in an amount of 50 mL, and the sample bottle was stoppered tightly and was allowed to stand at 40° C. for 2 weeks. Then, these light curable aqueous emulsions were each subjected to a molecular weight measurement with GPC (trade name: HLC-8220, manufactured by Tosoh Corp.).

When the amphiphilic urethane acrylate constituting each of the light curable aqueous emulsions is hydrolyzed, the generation of acrylic acid is taken to occur; accordingly, when no generation of acrylic acid occurred, it was determined that no hydrolysis occurred (in Tables 4 and 6, denoted as “none”).

Adhesiveness in Each of Examples 12 to 21

Each of the light curable aqueous emulsions of Examples 12 to 21 was applied onto a PVC film with a bar coater so as for the application thickness to be 10 μm; after an elapsed time of 90 seconds under the conditions of a temperature of 25° C. and a humidity of 40%, the applied emulsion layer was irradiated with ultraviolet light by using an LED lamp (an irradiator manufactured by Phoseon Technology, Inc., peak wavelength: 395 nm, illuminance: 1000 mW/m² (Gap: 6 mm), 2000 mJ/cm²).
Application conditions: Bar coater No. 9 (film thickness under dried condition: 4 to 6 μm)

A tape was bonded to each of the obtained coating films, and the adhesiveness of each of the coating films was evaluated on the basis of whether or not the coating film was peeled off when the tape was peeled off. The evaluation standards are as follows.

∘: No peeling occurred.

x: Peeling occurred.

The evaluation results are shown in Table 6.

TABLE 1

| | | Example 5 | Example 6 |
|---|---|---|---|
| Light curable aqueous emulsion | | b-1 | c-1 |
| Amphiphilic | a (Acryloyl group: 1) | — | — |
| urethane | b (Acryloyl groups: 3) | 36.7 | — |
| acrylates | c (Acryloyl groups: 5) | — | 36.7 |
| | d (Acryloyl groups: 5) | — | — |
| Photoradical | TPO | 3.3 | 3.3 |
| polymerization | | | |
| initiator | | | |
| Water | Ion exchanged water | 60.0 | 60.0 |
| Emulsifiability | | A | A |
| Viscosity [mPa · s] (25° C.) | | 25.0 | 11.0 |
| Curability | LED lamp, 395 nm, | 300 | 200 |
| | 1000 mW/cm² | | |

TABLE 2

| | | Ex- | Ex- | Ex- | | |
|---|---|---|---|---|---|---|
| | | am- | am- | am- | Exam- | Exam- |
| | | ple 7 | ple 8 | ple 9 | ple 10 | ple 11 |
| Light curable aqueous emulsion | | a-1 | d-1 | d-2 | d-3 | d-4 |
| Amphiphilic | a (Acryloyl | 28.5 | — | — | — | — |
| urethane | group: 1) | | | | | |
| acrylates | d (Acryloyl | — | 27.5 | 27.5 | 27.5 | 27.5 |
| | groups: 5) | | | | | |
| Radical | Aronix M-403 | 9.5 | 9.2 | — | — | — |
| polymerizable | Viscoat 802 | — | — | 9.2 | — | — |
| acrylates | Viscoat 1000 | — | — | — | 9.2 | — |
| | KU-DPU | — | — | — | — | 9.2 |
| Photoradical | TPO | 2.0 | 3.3 | 3.3 | 3.3 | 3.3 |
| polymerization | | | | | | |
| initiator | | | | | | |
| Water | Ion exchanged | 60.0 | 60.0 | 60.0 | 60.0 | 60.0 |
| | water | | | | | |
| Emulsifiability | | A | A | A | A | A |
| Viscosity [mPa · s] (25° C.) | | 9.0 | 36.0 | 25.0 | 31.0 | 24.0 |
| Curability | LED lamp, | 300 | 80 | 30 | 50 | 30 |
| | 395 nm, | | | | | |
| | 1000 mW/cm² | | | | | |

TABLE 3

| | | Comparative | Comparative | Comparative | Comparative | Comparative |
|---|---|---|---|---|---|---|
| | | Example 5 | Example 6 | Example 7 | Example 8 | Example 9 |
| Light curable aqueous | | p-1 | q-1 | q-2 | s-1 | t-1 |
| emulsion | | | | | | |
| Amphiphilic | p | 38.0 | — | — | — | — |
| urethane | (Acryloyl | | | | | |
| acrylates | group: | | | | | |
| | 10) | | | | | |
| | q | — | 38.0 | 27.5 | — | — |
| | (Acryloyl | | | | | |
| | groups: 6) | | | | | |
| | s | — | — | — | 38.0 | — |
| | (Acryloyl | | | | | |
| | group: 1) | | | | | |
| | t | — | — | — | — | 38.0 |
| | (Acryloyl | | | | | |
| | group: 1) | | | | | |
| Radical | Viscoat | — | — | 9.2 | — | — |
| polymerizable | 802 | | | | | |
| acrylates | | | | | | |
| Photoradical | TPO | 2.0 | 2.0 | 3.3 | 2.0 | 2.0 |
| polymerization | | | | | | |
| initiator | | | | | | |
| Water | Ion | 60.0 | 60.0 | 60.0 | 60.0 | 60.0 |
| | exchanged | | | | | |
| | water | | | | | |
| Emulsifiability | | C | A | B | B | C |
| Viscosity [mPa · s] (25° C.) | | 261.0 | 85.0 | 12 | 136.0 | 40.0 |
| Curability | LED lamp, | — | 300 | 150 | — | — |
| | 395 nm, | | | | | |
| | 1000 mW/cm² | | | | | |

TABLE 4

| | Example 9 | Example 11 |
|---|---|---|
| Light curable aqueous | d-2 | d-4 |
| emulsion | | |
| Hydrolyzability | None | None |

TABLE 5

| | | | Exam- | | Exam- | | Exam- | | Exam- | | Exam- | Exam- |
|---|---|---|---|---|---|---|---|---|---|---|---|---|
| | | | ple | Example | ple | Example | ple | Example | ple | Example | ple | ple |
| | | | 12 | 13 | 14 | 15 | 16 | 17 | 18 | 19 | 20 | 21 |
| Light curable aqueous emulsion | | | d-2 | d-5 | d-6 | d-7 | e-1 | e-2 | e-3 | e-4 | e-5 | e-6 |
| Amphiphilic urethane | | a (Acryloyl | — | — | — | — | — | — | — | — | — | — |
| acrylates | | group: 1) | | | | | | | | | | |
| | | b (Acryloyl | — | — | — | — | — | — | — | — | — | — |
| | | groups: 3) | | | | | | | | | | |
| | | c (Acryloyl | — | — | — | — | — | — | — | — | — | — |
| | | groups: 5) | | | | | | | | | | |
| | | d (Acryloyl | 27.5 | 27.4 | 26.2 | 26.1 | — | — | — | — | — | — |
| | | groups: 5) | | | | | | | | | | |
| | | e (Acryloyl | — | — | — | — | 23.3 | 23.9 | 21.6 | 21.6 | 21.6 | 21.6 |
| | | groups: 5) | | | | | | | | | | |
| Cross-linking thiol | | PHMP | — | — | 1.7 | 1.7 | — | 2.4 | 2.5 | 2.5 | 2.5 | 2.5 |
| Included | Radical | Aronix M-403 | — | — | — | — | — | — | — | — | — | — |
| substances | polymerizable | Viscoat 802 | 9.2 | 9.1 | 8.7 | 8.7 | 8.3 | 10.3 | 9.2 | 9.2 | 7.7 | 7.7 |
| | acrylates | Viscoat 1000 | — | — | — | — | — | — | — | — | — | — |
| | | KU-DPU | — | — | — | — | — | — | — | — | — | — |
| | Fluorescent | KCB | — | 0.13 | — | 0.07 | 0.07 | 0.07 | 0.06 | 0.06 | — | 0.06 |
| | brightening | | | | | | | | | | | |
| | agent | | | | | | | | | | | |
| | Urethane acrylate for fixing | | — | — | — | — | 1.7 | — | — | — | 1.5 | 1.5 |
| | Photoradical | TPO | 3.3 | 3.3 | 3.3 | 3.3 | 5 | 3.3 | 6.7 | 5 | 5 | 5 |
| | polymerization | DETX | — | — | — | — | 1.7 | — | — | 1.7 | 1.7 | 1.7 |
| | | initiators | | | | | | | | | | |

| | | | | | | | | | | | |
|---|---|---|---|---|---|---|---|---|---|---|---|
| Water | Ion exchanged | 60 | 60 | 60 | 60 | 60 | 60 | 60 | 60 | 60 | 60 |
| | water | | | | | | | | | | |

| | | | | | | | | | | |
|---|---|---|---|---|---|---|---|---|---|---|
| Total amount | 100.0 | 99.9 | 99.9 | 99.9 | 100.1 | 100.0 | 100.1 | 100.1 | 100.0 | 100.1 |

TABLE 6

| Ingredient | | Example | Example | Example | Example | Example | Example | Example | Example | Example | Example |
|---|---|---|---|---|---|---|---|---|---|---|---|
| name | Symbol etc. | 12 | 13 | 14 | 15 | 16 | 17 | 18 | 19 | 20 | 21 |
| Emulsion for evaluation test | | d-2-1 | d-5-1 | d-6-1 | d-7-1 | e-1-1 | e-2-1 | e-3-1 | e-4-1 | e-5-1 | e-6-1 |
| Light curable | d-2 | 30 | — | — | — | — | — | — | — | — | — |
| aqueous | d-5 | — | 30 | — | — | — | — | — | — | — | — |
| emulsion | d-6 | — | — | 30 | — | — | — | — | — | — | — |
| | d-7 | — | — | — | 30 | — | — | — | — | — | — |
| | e-1 | — | — | — | — | 30 | — | — | — | — | — |
| | e-2 | — | — | — | — | — | 30 | — | — | — | — |
| | e-3 | — | — | — | — | — | — | 30 | — | — | — |
| | e-4 | — | — | — | — | — | — | — | 30 | — | — |
| | e-5 | — | — | — | — | — | — | — | — | 30 | — |
| | e-6 | — | — | — | — | — | — | — | — | | 30 |
| Leveling agent | BYK-348 | 0.1 | 0.1 | 0.1 | 0.1 | 0.1 | 0.1 | 0.1 | 0.1 | 0.1 | 0.1 |
| Water | Ion | Balance | Balance | Balance | Balance | Balance | Balance | Balance | Balance | Balance | Balance |
| | exchanged | | | | | | | | | | |
| | water | | | | | | | | | | |
| Total amount | | 100 | 100 | 100 | 100 | 100 | 100 | 100 | 100 | 100 | 100 |
| Emulsifiability | | A | A | A | A | A | A | A | A | A | A |
| Viscosity [mPa · s] (25° C.) | | 2 | 2 | 2 | 2 | 3 | 3 | 3 | 3 | 3 | 3 |
| Curability | LED lamp, | C | A | B | A | AA | A | AA | AA | AA | AA |
| | 395 nm, | | | | | | | | | | |
| | 1000 mW/ | | | | | | | | | | |
| | cm² | | | | | | | | | | |

| | | | | | | | | | | |
|---|---|---|---|---|---|---|---|---|---|---|
| Hydrolyzability | None | None | None | None | None | None | None | None | None | None |
| Adhesiveness | X | X | X | X | ◯ | X | X | X | ◯ | ◯ |

Tables 1 to 3 show that the light curable aqueous emulsions (Examples) each having a weight average molecular weight of 1,000 to 10,000 and using the urethane acrylate having the specific structure represented by the foregoing general formula (1) are excellent in the emulsifiability in water of the urethane acrylate and are each low in the viscosity of the emulsion and excellent in the curability of the emulsion, as compared to the light curable aqueous emulsions (Comparative Examples) each using a conventional urethane acrylate.

As can be seen from Table 4, for each of Examples 9 and 11, no detection peak of acrylic acid was found, and the measurement results which were the same as the initial conditions were obtained. Accordingly, it may be determined no hydrolysis occurred.

As can be seen from these results, the amphiphilic urethane acrylates constituting the light curable aqueous emulsions of the present invention are excellent in hydrolysis resistance.

Also, as can be seen from Table 6, the emulsions using specified cross-linked urethane acrylates are extremely excellent in curability as compared to the emulsions using non-cross-linked urethane acrylates.

From Table 6, the emulsion of Example 12 corresponding to the emulsion obtained by diluting the emulsion of Example 9 appears to be poor in curability. However, as shown in Example 9, the emulsion of Example 9 was cured with an irradiation energy as small as 30 mJ/cm², and hence is excellent in curability (see Table 2). Thus, the present inventors have found that the emulsions of Examples 13 to 21 are extremely excellent in curability, specifically due to the cross-linking of the specified urethane(meth)acrylates.

On the basis of the results obtained above, here is discussed the mechanism of excellent effects achieved by the cross-linked urethane(meth)acrylates of the present invention. For the purpose of obtaining films excellent in curability from low molecular weight urethane(meth)acrylates, it is required to make higher the molecular weights by a large amount of irradiation of ultraviolet light. Accordingly, it is inferred that the molecular weight of the urethane(meth)acrylate made larger by cross-linking allows even a smaller amount of ultraviolet light irradiation to result in a larger effect of increasing the molecular weight (even the reaction of a small amount of acryloyl groups results in insolubilization of the urethane(meth)acrylate), and thus the curability is made more excellent.

The present invention is not limited to the aforementioned discussion. The present inventors have verified that in the case where used are urethane(meth)acrylates other than the amphiphilic urethane(meth)acrylates having a specified structure in the present invention, even when such urethane(meth)acrylates are successfully cross-linked, no stable aqueous emulsions can be obtained.

On the basis of the results obtained above, also discussed are the reasons for the results such that the urethane acrylates used in Comparative Examples did not yield cross-linked urethane acrylates. In each of Comparative Examples 5, 7 and 8, a possible reason may be such that a cross-linking agent was not able to be included in the oil phase because of the poor emulsifiability of the urethane acrylate, and the urethane acrylate was gelified in the course of the reaction. In Comparative Example 6, a possible reason may be such that the viscosity was not low although the cross-linked urethane(meth)acrylate (cross-linked emulsion) was able to be obtained, and the curability was also inferred to be satisfactory. The present invention is not limited to the aforementioned discussion.

What is claimed is:

1. A urethane(meth)acrylate being represented by the following general formula (1) and having a weight average molecular weight of 1,000 to 10,000:
A¹-O—(CONH—B¹—NHCOO—C¹—O)ₙ—CONH—B¹—NH—COO-D¹ (1)
wherein in formula (1), n represents a natural number of 1 to 30, A¹ represents a residue of a hydroxyl group-containing (meth)acrylate, B¹ represents a residue of diisocyanate, C¹ represents a residue of a diol of an acyclic hydrocarbon or a cyclic hydrocarbon, and D¹ represents a residue of a polyoxyalkylene glycol monoalkyl ether.

2. The urethane(meth)acrylate according to claim 1, obtained by allowing to react with each other the hydroxyl group-containing (meth)acrylate, the diisocyanate, the diol of the acyclic hydrocarbon or the cyclic hydrocarbon and the polyoxyalkylene glycol monoalkyl ether.

3. The urethane(meth)acrylate according to claim 1, wherein the diisocyanate is one or more selected from the group consisting of isophorone diisocyanate, hexamethylene diisocyanate, hydrogenated xylylene diisocyanate and hydrogenated diphenylmethane diisocyanate.

4. The urethane(meth)acrylate according to claim 1, wherein the number of carbon atoms in the diol of the acyclic hydrocarbon or the cyclic hydrocarbon is 6 to 20.

5. The urethane(meth)acrylate according to claim 4, wherein the diol, having a number of carbon atoms of 6 to 20, of the acyclic hydrocarbon or the cyclic hydrocarbon is one or more selected from the group consisting of 1,8-octanediol, 1,9-nonanediol, 1,10-decanediol, 1,11-undecanediol, 1,12-dodecanediol, 1,13-tridecanediol, 1,14-tetradecanediol, 1,15-pentadecanediol, 1,18-octadecanediol, 1,19-nonadecanedioi, 1,20-eicosanediol, polypropylene glycol, aliphatic polycarbonate polyol, aliphatic polyester polyol, aliphatic polycaprolactone diol, hydrogenated bisphenol A, ethylene oxide-modified hydrogenated bisphenol A, propylene oxide-modified hydrogenated bisphenol A, 1,4-cyclohexanediol and tricyclodecanedimethanol.

6. The urethane(meth)acrylate according to claim 1, wherein the hydroxyl group-containing (meth)acrylate is at least one of polypropylene glycol mono(meth)acrylate, pentaerythritol tri(meth)acrylate and dipentaerythritol penta(meth)acrylate.

7. The urethane(meth)acrylate according to claim 1, wherein the polyoxyalkylene glycol monoalkyl ether is represented by the following general formula (2):
HO—(CH₂CH₂O)ₘ—R (2)
wherein in formula (2), R represents an alkyl group and m represents a natural number of 9 to 90.

8. A cross-linked urethane(meth)acrylate comprising a constitutional unit including the urethane(meth)acrylate according to claim 1.

9. The cross-linked urethane(meth)acrylate according to claim 8, prepared by cross-linking with a bifunctional or higher functional cross-linking agent.

10. The cross-linked urethane(meth)acrylate according to claim 9, wherein the cross-linking agent is a mercapto group-containing compound.

11. A light curable aqueous emulsion comprising:
a urethane(meth)acrylate according to claim 1 or a cross-linked urethane(meth)acrylate according to claim 8; and
the compound having a radical polymerizable group(s) and the photoradical polymerization initiator emulsified and dispersed with the urethane(meth)acrylate or the cross-linked urethane(meth)acrylate.

12. The light curable aqueous emulsion according to claim 11, wherein the compound having a radical polymerizable group(s) is a compound having in the molecule thereof three or more (meth)acryloyl groups.

13. The light curable aqueous emulsion according to claim 11, wherein the photoradical polymerization initiator is a hydrophobic photopolymerization initiator.

14. The light curable aqueous emulsion according to claim 11, wherein the photoradical polymerization initiator comprises two or more photoradical polymerization initiators including at least a thioxanthone-based photoradical polymerization initiator.

15. The light curable aqueous emulsion according to claim 11, wherein the compound having a radical polymerizable group(s) comprises a urethane(meth)acrylate for fixing.

16. The light curable aqueous emulsion according to claim 11, further comprising a fluorescent brightening agent.

17. A production method of the urethane(meth)acrylate according to claim 1, the method comprising:
a first step of obtaining a first reaction product represented by the following general formula (1a),
OCN—(B¹—NHCOO—C¹—O)ₙ—CONH—B¹—NCO (1a)
by allowing the diisocyanate and the dial of the acyclic hydrocarbon or the cyclic hydrocarbon to react with each other;
a second step of obtaining a second reaction product represented by the following general formula (1b),
OCN—(B¹—NHCOO—C¹—O)ₙ—CONH—B¹—NH—COO-D¹ (1b)
by allowing the first reaction product and the polyoxyalkylene glycol monoalkyl ether to react with each other; and
a third step of allowing the second reaction product and the hydroxyl group-containing (meth)acrylate to react with each other.

18. The production method of the urethane(meth)acrylate according to claim 17, wherein;
in the first step, the molar ratio between the diisocyanate and the dial of the acyclic hydrocarbon or the cyclic hydrocarbon is 5:1 to 5:4;
in the second step, the molar ratio between the first reaction product and the polyoxyalkylene glycol monoalkyl ether is 1:0.5 to 1:1; and
in the third step, the molar ratio between the second reaction product and the hydroxyl group-containing (meth)acrylate is 1:1.5 to 1:1.

19. A production method of the cross-linked urethane(meth)acrylate according to claim 8, further comprising a fourth step of allowing the urethane(meth)acrylate represented by the foregoing general formula (1), obtained by the production method according to claim 17, and the bifunctional or higher functional cross-linking agent to react with each other.

20. The production method of the cross-linked urethane(meth)acrylate according to claim 19, wherein in the fourth step, a compound having in the molecule thereof three or more (meth)acryloyl groups is further allowed to react with the bifunctional or higher functional cross-linking agent.

21. The production method of the cross-linked urethane(meth)acrylate according to claim 19, wherein in the fourth step, a urethane(meth)acrylate for fixing is further added.

22. The production method of the cross-linked urethane(meth)acrylate according to claim 20, wherein in the fourth step, the ratio between the content of the urethane(meth)acrylate represented by the foregoing general formula (1) and the compound having in the molecule thereof three or more (meth)acryloyl groups and the content of the bifunctional or higher functional cross-linking agent is 100:1 to 100:10 in terms of mass.
